(19) United States
(12) Patent Application Publication
(10) Pub. No.: US 2025/0365192 A1
(43) Pub. Date: Nov. 27, 2025

(54) METHOD AND APPARATUS FOR CONSTRUCTING ENTERPRISE PRIVATE NETWORK AND PROVIDING SERVICE

(71) Applicant: Samsung Electronics Co., Ltd., Suwon-si (KR)

(72) Inventors: Sunil KUMAR, Suwon-si (KR); Shijae LEE, Suwon-si (KR)

(21) Appl. No.: 19/287,185

(22) Filed: Jul. 31, 2025

Related U.S. Application Data
(63) Continuation of application No. PCT/KR2024/001212, filed on Jan. 25, 2024.

(30) Foreign Application Priority Data
Feb. 3, 2023 (KR) 10-2023-0015096
Mar. 6, 2023 (KR) 10-2023-0029383

(51) Int. Cl. H04L 41/0803; H04L 41/06; H04L 41/0894; H04L 41/28; H04W 8/08; H04W 12/06

(52) U.S. Cl. CPC H04L 41/0803; H04L 41/06; H04L 41/0894; H04L 41/28; H04W 8/08; H04W 12/06

(57) ABSTRACT

A method performed by a secure network abstraction function (SNAF) entity for operating a private network is provided. The method includes receiving a first control message from a first network entity, and performing a control operation on a second network entity on the basis of the first control message, wherein the first network entity is a control center included in the private network, and the second network entity is at least one of a session management function (SMF) entity, an access and mobility management function (AMF) entity, or a user plane function (UPF) entity, and wherein the first network entity and the SNAF entity are connected via an application programming interface (API), and the SNAF entity and the second network entity are connected via a service-based interface (SBI).

### CROSS-REFERENCE TO RELATED APPLICATION(S)

This application is a continuation application, claiming priority under 35 U.S.C. § 365(c), of an International application No. PCT/KR2024/001212, filed on Jan. 25, 2024, which is based on and claims the benefit of a Korean patent application number 10-2023-0015096, filed on Feb. 3, 2023, in the Korean Intellectual Property Office, and of a Korean patent application number 10-2023-0029383, filed on Mar. 6, 2023, in the Korean Intellectual Property Office, the disclosure of each of which is incorporated by reference herein in its entirety.

### BACKGROUND

### 1. Field

The disclosure relates to a private network for enterprise use. More particularly, the disclosure relates to a method and an apparatus for constructing an enterprise private network and providing services.

### 2. Description of Related Art

To meet the demand for wireless data traffic having increased since deployment of 4th generation (4G) communication systems, efforts have been made to develop an improved 5th generation (5G) or pre-5G communication system. Therefore, the 5G or pre-5G communication system is also called a “beyond 4G network” communication system or a “post long term evolution (post LTE)” system.

The 5G communication system is considered to be implemented in ultrahigh frequency bands (e.g., 60 GHz bands) so as to accomplish higher data rates. To decrease propagation loss of the radio waves and increase the transmission distance in the ultrahigh frequency bands, beamforming, massive multiple-input multiple-output (massive MIMO), full dimensional MIMO (FD-MIMO), array antenna, analog beam forming, large scale antenna techniques are discussed in 5G communication systems.

In addition, in 5G communication systems, development for system network improvement is under way based on advanced small cells, cloud radio access networks (cloud RANs), ultra-dense networks, device-to-device (D2D) communication, wireless backhaul, moving network, cooperative communication, coordinated multi-points (COMP), reception-end interference cancellation and the like.

In the 5G system, hybrid frequency shifting keying (FSK) and quadrature amplitude modulation (QAM) (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have also been developed. With the advance of wireless communication systems as described above, various services can be provided, and accordingly there is a need for schemes to smoothly provide these services. In particular, there is a need for a technology to support services newly requested in a wireless communication system.

Unlike public networks, an enterprise private network may have unique service requirements specific to the enterprise, and may utilize only a portion of functions required by the enterprise among functions defined in the 3rd generation partnership project (3GPP) standards. Accordingly, although a 4G network entity (NE), a 5G network function (NF), or the like may be deployed for the purpose of providing a path for subscriber traffic delivery and controlling the path for subscriber traffic delivery, based on the criteria defined in the 3GPP standard, not all functions defined in the standard may be utilized. In some cases, only some functions required by the enterprise are used, or additional functions not defined in the 3GPP standards may be required. Therefore, in such enterprise private network environments, there is a need for a solution that enables the private network to use open interfaces instead of standardized interfaces, and to be constructed in a cost-effective and efficient manner.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an apparatus and a method capable of effectively providing a service in an enterprise private network.

Additional aspects will be set forth in part in the description which follows and, in part, will be apparent from the description, or may be learned by practice of the presented embodiments.

In accordance with an aspect of the disclosure, a method of a secure network abstraction function (SNAF) entity for operating a private network is provided. The method includes receiving a first control message from a first network entity, and performing a control operation for a second network entity, based on the first control message, wherein the first network entity is a control center included in the private network, and the second network entity is at least one of a session management function (SMF) entity, an access and mobility management function (AMF) entity, or a user plane function (UPF) entity, and wherein the first network entity and the SNAF entity are connected via an application programming interface (API), and the SNAF entity and the second network entity are connected via a service-based interface (SBI).

In accordance with another aspect of the disclosure, a secure network abstraction function (SNAF) entity for operating a private network is provided. The SNAF entity includes a transceiver, memory, including one or more storage media, storing instructions, and at least one processor communicatively coupled to the transceiver and memory, wherein the instructions, when executed by the at least one processor individually or collectively, cause the SNAF entity to receive a first control message from a first network entity, and perform a control operation for a second network entity, based on the first control message, wherein the first network entity is a control center included in the private network, and the second network entity is at least one of a session management function (SMF) entity, an access and mobility management function (AMF) entity, or a user plane function (UPF) entity, and wherein the first network entity and the SNAF entity are connected via an application programming interface (API), and the SNAF entity and the second network entity are connected via a service-based interface (SBI).

In accordance with another aspect of the disclosure, one or more non-transitory computer-readable storage media storing one or more computer programs including computer-executable instructions that, when executed by one or more processors of a secure network abstraction function (SNAF) entity individually or collectively, cause the SNAF entity to perform operations, the operations including receiving a first control message from a first network entity, and performing a control operation for a second network entity, based on the first control message, wherein the first network entity is a control center included in a private network, and the second network entity is at least one of a session management function (SMF) entity, an access and mobility management function (AMF) entity, or a user plane function (UPF) entity, and wherein the first network entity and the SNAF entity are connected via an application programming interface (API), and the SNAF entity and the second network entity are connected via a service-based interface (SBI).

A method and an apparatus according to various embodiments of the disclosure can reduce the burden of deploying all 3GPP-based network functions and operational complexity by applying a secure network abstraction function (SNAF) to an enterprise private network. In addition, by optimizing the use of network resources, capital investment by the enterprise may be minimized, thereby allowing the enterprise to more stably, easily, and rapidly deploy the enterprise private network.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a communication network including core network entities (or core network functions) in a wireless communication system according to an embodiment of the disclosure;

FIG. 2 illustrates a wireless environment including a core network in a wireless communication system according to an embodiment of the disclosure;

FIG. 3 illustrates a structure of a core network entity in a wireless communication system according to an embodiment of the disclosure;

FIG. 4 illustrates a structure of a base station in a wireless communication system according to an embodiment of the disclosure;

FIG. 5 illustrates a structure of a use equipment (UE) in a wireless communication system according to an embodiment of the disclosure;

FIG. 6 illustrates a structure of an enterprise private network according to an embodiment of the disclosure;

FIG. 7 illustrates a structure of an enterprise private network according to an embodiment of the disclosure;

FIG. 8 illustrates an internal structure and interface of a secure network abstraction function (SNAF) according to an embodiment of the disclosure;

FIG. 9 illustrates a basic operational sequence of an SNAF according to an embodiment of the disclosure;

FIG. 10 illustrates a signal flow in a SNAF-based certificate acquisition and delivery procedure according to an embodiment of the disclosure;

FIG. 11 illustrates a sequence of SNAF-based certificate acquisition and delivery according to an embodiment of the disclosure;

FIG. 12 illustrates a signal flow in a SNAF-based subscriber access control procedure according to an embodiment of the disclosure;

FIG. 13 illustrates a sequence of SNAF-based subscriber access control according to an embodiment of the disclosure;

FIG. 14 illustrates a signal flow in a SNAF-based session authentication procedure according to an embodiment of the disclosure;

FIG. 15 illustrates a sequence of SNAF-based session authentication according to an embodiment of the disclosure;

FIG. 16 illustrates a signal flow in a SNAF-based policy and quality of service (QOS) procedure according to an embodiment of the disclosure;

FIG. 17 illustrates a sequence of SNAF-based policy and QoS procedures according to an embodiment of the disclosure;

FIG. 18 illustrates a signal flow in a SNAF-based usage monitoring procedure according to an embodiment of the disclosure;

FIG. 19 illustrates a SNAF-based usage monitoring sequence according to an embodiment of the disclosure;

FIG. 20 illustrates a signal flow in a SNAF-based UE status monitoring procedure according to an embodiment of the disclosure;

FIG. 21 illustrates a SNAF-based UE status monitoring sequence according to an embodiment of the disclosure;

FIG. 22 illustrates a signal flow in a SNAF-based enterprise private network monitoring procedure according to an embodiment of the disclosure; and

FIG. 23 illustrates a SNAF-based enterprise private network monitoring sequence according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In describing the embodiments, descriptions related to technical contents well-known in the art and not associated directly with the disclosure will be omitted. Such an omission of unnecessary descriptions is intended to prevent or reduce obscuring of the main idea of the disclosure and more clearly transfer the main idea.

For the same reason, in the accompanying drawings, some elements may be exaggerated, omitted, or schematically illustrated. Further, the size of each element does not completely reflect the actual size. In the drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements. In describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description, a base station is an entity that allocates resources to terminals, and may be at least one of a gNode B, an eNode B, a Node B, a base station (BS), a wireless access unit comprising circuitry, a base station controller comprising circuitry, and a node on a network. A terminal may include a user equipment (UE), a mobile station (MS), a cellular phone, a smartphone, a computer, or a multimedia system capable of performing communication functions. In the disclosure, a “downlink (DL)” refers to a radio link via which a base station transmits a signal to a terminal, and an “uplink (UL)” refers to a radio link via which a terminal transmits a signal to a base station. Furthermore, in the following description, LTE or long term evolution advanced (LTE-A) systems may be described by way of example, but the example embodiments may also be applied to other communication systems having similar technical backgrounds or channel types. Examples of such communication systems may include 5th generation mobile communication technologies (5G, new radio, and NR) developed beyond LTE-A, and in the following description, the “5G” may be the concept that covers the exiting LTE, LTE-A, or other similar services. In addition, based on determinations by those skilled in the art, the example embodiments may also be applied to other communication systems through some modifications without significantly departing from the scope of the disclosure.

Herein, it will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide operations for implementing the functions specified in the flowchart block or blocks.

Furthermore, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used herein, the “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” or may be implemented to reproduce one or more CPUs within a device or a security multimedia card. Furthermore, the “unit” in the embodiments may include one or more processors.

In the following description, some of terms and names defined in the 3rd generation partnership project long term evolution (3GPP LTE)-based communication standards (e.g., standards for 5G, NR, LTE, or similar systems) may be used for the sake of descriptive convenience. However, the disclosure is not limited by these terms and names, and may be applied in the same way to systems that conform other standards.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used.

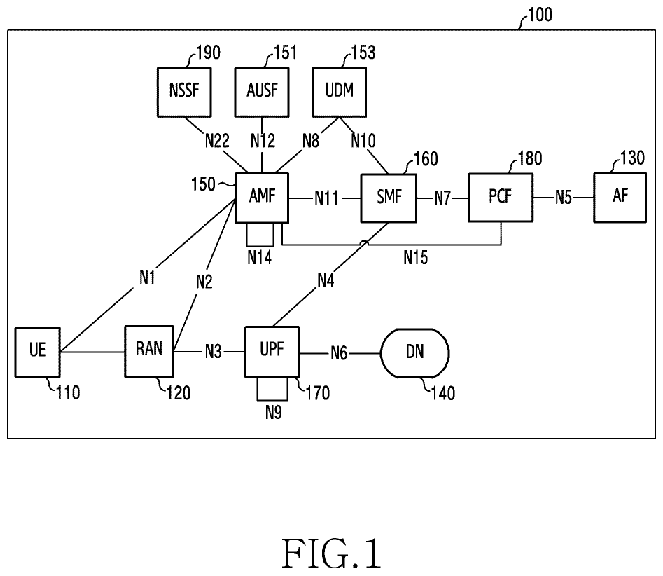

According to embodiments of the disclosure, although a private network (PN) for enterprise use is much smaller in scale than a public communication network, it may still be constructed based on 3GPP standards applied to public communication networks due to the basic concept of communication networks, and may be configured by a wide variety of network entities (NEs) and/or network functions (NFs). Accordingly, the private network for enterprise use may include at least one network entity or at least one of network functions that constitutes the 5G core (5GC) network (e.g., at least one of the network entities or network functions described in FIG. 1 which will be described later). Therefore, the at least one network entity or network function included in the enterprise private network may perform the same or similar operations as those of the network entities or network functions constituting the 5GC network.

Hereinafter, embodiments of the disclosure may describe a device for an enterprise private network that may be constructed based on 3GPP standards and a method for configuring an enterprise private network. In addition, in the embodiments of the disclosure, the enterprise private network may refer to an external network (e.g., an enterprise data network) of a 3GPP network. Alternatively, the enterprise private network may refer to an overall network including both the 3GPP network and an external network of the 3GPP network. In the embodiments of the disclosure, the enterprise private network may be referred to as a 5G private network, a private network, or an enterprise network.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

FIG. 1 illustrates a communication network including core network entities (or core network functions) in a wireless communication system according to an embodiment of the disclosure.

A 4G mobile communication network may include a 5G user equipment (5G UE) 110, a 5G radio access network (5G RAN) 120, and a 5G core network 200.

The 5G core network may include network functions, such as an access and mobility management function (AMF) 150 that provides a mobility management function of the UE, a session management function (SMF) 160 that provides a session management function, a user plane function (UPF) 170 that serves to transfer data, a policy control function (PCF) 180 that provides a policy control function, a unified data management (UDM) 153 that functions to manage data, such as subscriber data and policy control data, or a unified data repository (UDR) that stores data of various network functions.

Referring to FIG. 1, the user equipment (UE) 110 may perform communication through a radio channel, that is, an access network, established between the UE and a base station (e.g., eNB or gNB). In some embodiments, the UE 110 refers to a device used by a user, and may be a device configured to provide a user interface (UI). For example, the UE 110 may be a UE equipped in a vehicle for driving. In some other embodiments, the UE 110 may be an autonomous vehicle or a device that performs machine type communication (MTC) operated without the user's involvement. The UE may be referred to as not only an “electronic device”, but also a “terminal”, a “vehicle terminal”, a “user equipment (UE)”, a “mobile station”, a “subscriber station”, a “remote terminal”, a “wireless terminal”, “a user device”, or any other term having an equivalent technical meaning thereto. As a UE device, not only the UE, but also a customer-premises equipment (CPE) or a dongle type UE may be used. The customer-premises equipment may be connected to an NG-RAN node like a UE, and may provide a network to other communication equipment (e.g., laptop).

Referring to FIG. 1, the AMF 150 may provide a function for access and mobility management in units of UEs 110, and basically, each one UE 110 may be connected to one AMF 150. Specifically, the AMF 150 may perform at least one function among signaling between core network nodes for mobility between 3GPP access networks, an interface (N2 interface) between radio access networks (e.g., 5G RAN) 120, NAS signaling with the UE 110, identification of the SMF 160, and provision of transfer of a session management (SM) message between the UE 110 and the SMF 160. Some or all functions of the AMF 150 may be supported in a single instance of one AMF 150.

Referring to FIG. 1, the SMF 160 may provide a session management function, and if the UE 110 has multiple sessions, the sessions may be managed by different SMFs 160, respectively. Specifically, the SMF 160 may perform at least one function among session management (e.g., session establishment including tunnel maintenance between the UPF 170 and the access network node, and modification and release thereof), selection and control of a user plane (UP) function, a configuration of traffic steering for routing traffic from the UPF 170 to an appropriate destination, an endpoint of an SM part of an NAS message, downlink data notification (DDN), and an initiator of AN-specific SM information (e.g., transfer to the access network through the N2 interface via the AMF 150). Some or all functions of the SMF 160 may be supported in a single instance of one SMF 160.

In 3GPP systems, conceptual links connecting network functions (NFs) in the 5G system may be referred to as “reference points”. The reference points may also be referred to as “interfaces”. In the following, reference points included in the 5G system architecture described throughout FIG. 1 to FIG. 7 are exemplified below.
N1: A reference point between a UE 110 and an AMF 150
N2: A reference point between an (R)AN 120 and an AMF 150
N3: A reference point between an (R)AN 120 and a UPF 170
N4: A reference point between an SMF 160 and a UPF 170
N5: A reference point between a PCF 180 and an AF 130
N6: A reference point between a UPF 170 and a DN 140
N7: A reference point between an SMF 160 and a PCF 180
N8: A reference point between a UDM 153 and an AMF 150
N9: A reference point between two core UPFs 170
N10: A reference point between a UDM 153 and an SMF 160
N11: A reference point between an AMF 150 and an SMF 160
N12: A reference point between an AMF 150 and an authentication server function (AUSF) 151
N13: A reference point between a UDM 153 and an AUSF 151
N14: A reference point between two AMFs 150
N15: A reference point between a PCF 180 and an AMF 150 for a non-roaming scenario, and a reference point between a PCF 180 in a visited network and an AMF 150 for a roaming scenario

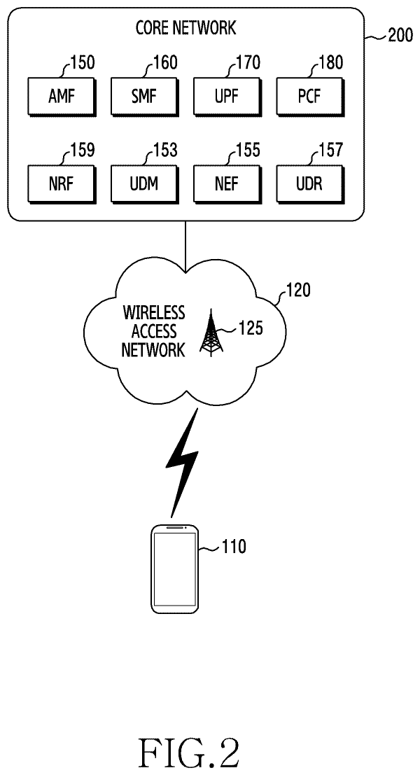

FIG. 2 illustrates a wireless environment including a core network in a wireless communication system according to an embodiment of the disclosure.

Referring to FIG. 2, a wireless communication system may include a radio access network (RAN) 120 and a core network (CN) 200.

The RAN 120 is a network directly connected to a user device, for example, the UE 110, and is an infrastructure that provides wireless access to the UE 110. The RAN 120 includes a set of multiple base stations including a base station 125, and the multiple base stations may perform communication through interfaces established therebetween. At least some of the interfaces among the multiple base stations may be wired or wireless. The base station 125 may have a structure in which a central unit (CU) and a distributed unit (DU) are separated from each other. In this case, one CU may control multiple DUs. The base station 125 may be referred to as, in addition to a base station, an “access point (AP)”, a “gNB (next generation node B)”, a “5th generation node (5G node)”, a “wireless point”, a “transmission/reception point (TRP)”, or other terms having a technical meaning equivalent thereto. The UE 110 may access the RAN 120 and communicate with the base station 125 through a wireless channel. The UE 110 may be referred to as, in addition to a terminal, a “user equipment (UE)”, a “mobile station”, a “subscriber station,” a “remote terminal,” a “wireless terminal,” or a “user device,” or other terms having a technical meaning equivalent thereto.

The CN 200 is a network that manages the entire system, and may control the RAN 120 and process data and control signals for the UE 110 transmitted or received via the RAN 120. The CN 200 may perform various functions including control of a user plane and a control plane, processing of mobility, management of subscriber information, charging, and linkage with a different type of system (e.g., long-term evolution (LTE) system). To perform the various functions, the CN 200 may include multiple entities that have different network functions (NFs) and are functionally separated from each other. For example, the CN 200 may include the access and mobility management function (AMF) 150, the session management function (SMF) 160, the user plane function (UPF) 170, the policy control function (PCF) 180, a network repository function (NRF) 159, the unified data management (UDM) 153, a network exposure function (NEF) 155, and a unified data repository (UDR) 157.

The UE 110 may be connected to the RAN 120 to access the AMF 150 that performs a mobility management function for the CN 200. The AMF 150 is a function or device that serves both access to the RAN 120 and mobility management for the UE 110. The SMF 160 is an NF that manages a session. The AMF 150 may be connected to the SMF 160, and may route a session-related message for the UE 110 to the SMF 160. The SMF 160 may connect to the UPF 170 to allocate a user plane resource to be provided to the UE 110, and establish a tunnel between the base station 125 and the UPF 170 for data transmission. The PCF 180 may control information related to charging and a policy for a session used by the UE 110. The NRF 159 may store information on NFs installed in a mobile communication service provider network, and notify of the stored information. The NRF 159 may be connected to all NFs. Each NF registers itself in the NRF 159 when starting to be operated by the service provider network, thereby notifying the NRF 159 that the NF is being operated in the network. The UDM 153 is an NF that performs a role similar to that of a home subscriber server (HSS) of a 4G network, and may store subscription information of the UE 110 or context used by the UE 110 in the network.

The NEF 155 may connect a 3rd party server to an NF in a 5G mobile communication system. Further, the NEF may provide data to the UDR 157, and may update data or obtain data. The UDR 157 may store subscription information of the UE 110, policy information, data exposed to the outside, or information required for a 3rd party application. The UDR 157 may also provide stored data to another NF.

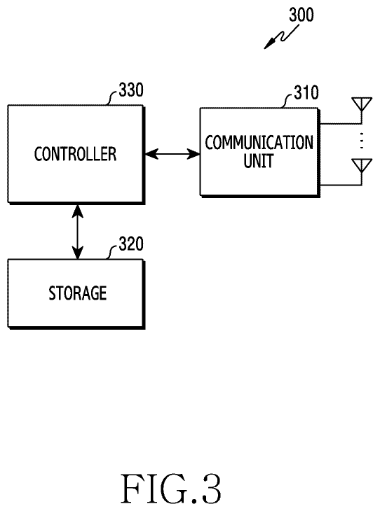

FIG. 3 illustrates a structure of a core network entity in a wireless communication system according to an embodiment of the disclosure.

The structure 300 illustrated in FIG. 3 may be understood as a structure of a device having at least one of the network functions 150, 153, 155, 157, 160, 170, 180, and 190 in FIG. 1. As used herein, such terms as “ . . . unit” and “-er” refer to a unit configured to process at least one function or operation, and may be implemented as hardware, software, or a combination of hardware and software.

Referring to FIG. 3, the core network entity may include a communication unit 310, a storage unit 320, and a controller 330.

The communication unit 310 provides an interface for communicating with other devices in the network. That is, the communication unit 310 converts a bitstring, transmitted from the core network entity to any other device, into a physical signal, and converts a physical signal, received from any other device, into a bitstring. The communication unit 310 may transmit/receive signals. Accordingly, the communication unit 310 may be referred to as a modem, a transmitter, a receiver, or a transceiver. The communication unit 310 enables the core network entity to communicate with other devices or the system via a backhaul connection (e.g., wired backhaul or wireless backhaul) or via a network.

The storage unit 320 may store basic programs, application programs, and data, such as configuration information, for operation of the main base station. The storage unit 320 may include volatile memory, nonvolatile memory, or a combination of volatile memory and nonvolatile memory. In addition, the storage unit 320 provides the stored data at the request of the controller 330.

The controller 330 controls the overall operation of the core network entity. For example, the controller 330 transmits/receives signals through the communication unit 310. In addition, the controller 330 records data in the storage unit 320 and reads the data from the storage unit 320. To this end, the controller 330 may include at least one processor. According to various embodiments, the controller 330 may control to perform synchronization by using a wireless communication network. For example, the controller 330 may control the core network entity to perform operations according to various embodiments as described below.

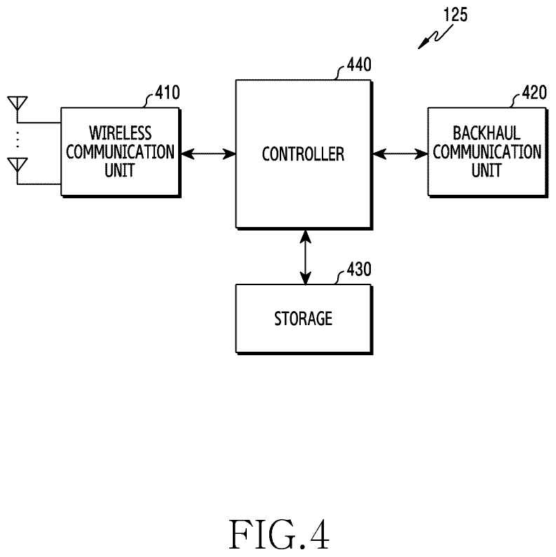

FIG. 4 illustrates a structure of a base station in a wireless communication system according to an embodiment of the disclosure.

The structure illustrated in FIG. 4 may be understood as a structure of the base station 125. As used herein, such terms as “ . . . unit” and “ . . . er” refer to a unit configured to process at least one function or operation, and may be implemented as hardware, software, or a combination of hardware and software.

Referring to FIG. 4, the base station includes a wireless communication unit 410, a backhaul communication unit 420, a storage unit 430, and a controller 440.

The wireless communication unit 410 performs functions for transmitting/receiving signals through a radio channel. For example, the wireless communication unit 410 performs functions of conversion between baseband signals and bitstrings according to the physical layer specifications of the system. For example, during data transmission, the wireless communication unit 410 encodes and modulates a transmitted bitstring to generate complex symbols. In addition, during data reception, the wireless communication unit 410 demodulates and decodes a baseband signal to reconstruct a received bitstring.

Furthermore, the wireless communication unit 410 up-converts a baseband signal to an RF band signal, transmits the same through an antenna, and down-converts an RF band signal received through the antenna to a baseband signal. To this end, the wireless communication unit 410 may include a transmission filter, a reception filter, an amplifier, a mixer, an oscillator, a digital to analog converter (DAC), an analog to digital converter (ADC), and the like. In addition, the wireless communication unit 410 may include multiple transmission/reception paths. Furthermore, the wireless communication unit 410 may include at least one antenna array including multiple antenna elements.

In terms of hardware, the wireless communication unit 410 may include a digital unit and an analog unit, and the analog unit may include multiple sub-units according to operation power, frequencies, etc. The digital unit may be implemented by at least one digital signal processor (DSP).

The wireless communication unit 410 transmits and receives signals as described above. Accordingly, all or part of the wireless communication unit 410 may be referred to as a “transmitter”, a “receiver”, or a “transceiver”. In addition, as used in the following description, the meaning of “transmission and reception performed through a radio channel” includes the meaning that the above-described processing is performed by the wireless communication unit 410.

The backhaul communication unit 420 provides an interface for performing communication with other nodes in the network. That is, the backhaul communication unit 420 converts a bitstring, transmitted from the base station to any other node, for example, any other access node, any other base station, an upper node, or a core network, into a physical signal, and converts a physical signal, received from any other node, into a bitstring.

The storage unit 430 may store basic programs, application programs, and data, such as configuration information, for operation of the main base station. The storage unit 430 may include volatile memory, nonvolatile memory, or a combination of volatile memory and nonvolatile memory. In addition, the storage unit 430 provides the stored data at the request of the controller 440.

The controller 440 controls the overall operation of the base station. For example, the controller 440 transmits and receives signals through the wireless communication unit 410 or the backhaul communication unit 420. In addition, the controller 440 records data in the storage unit 430 and reads the data from the storage unit 430. Furthermore, the controller 440 may perform functions of protocol stacks required by communication specifications. According to another embodiment, the protocol stack may be included in the wireless communication unit 410. To this end, the controller 440 may include at least one processor. According to various embodiments, the controller 440 may control the base station to perform operations according to various embodiments as described below.

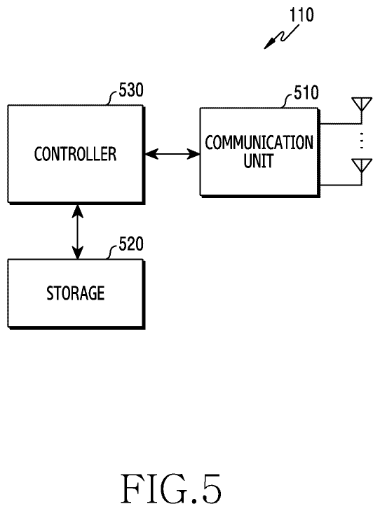

FIG. 5 illustrates a structure of a UE in a wireless communication system according to an embodiment of the disclosure.

The structure illustrated in FIG. 5 may be understood as a structure of the UE 110. As used herein, such terms as “ . . . unit” and “ . . . er” refer to a unit configured to process at least one function or operation, and may be implemented as hardware, software, or a combination of hardware and software.

Referring to FIG. 5, the UE may include a communication unit 510, a storage unit 520, and a controller 530.

The communication unit 510 performs functions for transmitting/receiving signals through a radio channel. For example, the communication unit 510 performs functions of conversion between baseband signals and bitstrings according to the physical layer specifications of the system. For example, during data transmission, the communication unit 510 generates complex symbols by encoding and modulating a transmission bitstream. In addition, during data reception, the communication unit 510 demodulates and decodes a baseband signal to restore a received bitstring. In addition, the communication unit 510 up-converts a baseband signal to an RF band signal, transmits the same through an antenna, and down-converts an RF band signal received through the antenna to a baseband signal. For example, the communication unit 510 may include a transmission filter, a reception filter, an amplifier, a mixer, an oscillator, a DAC, and an ADC.

In addition, the communication unit 510 may include multiple transmission/reception paths. Moreover, the communication unit 510 may include at least one antenna array including multiple antenna elements. In terms of hardware, the communication unit 510 may include a digital circuit and an analog circuit (e.g., a radio frequency integrated circuit (RFIC)). The digital circuit and the analog circuit may be implemented as a single package. In addition, the communication unit 510 may include multiple RF chains. Furthermore, the communication unit 510 may perform beamforming.

The communication unit 510 transmits and receives signals as described above. Accordingly, all or part of the communication unit 510 may be referred to as a “transmitter”, a “receiver”, or a “transceiver”. In addition, as used in the following description, the meaning of “transmission and reception performed through a radio channel” includes the meaning that the above-described processing is performed by the communication unit 510.

The storage unit 520 may store basic programs, application programs, and data, such as configuration information, for operation of the main base station. The storage unit 520 may include volatile memory, nonvolatile memory, or a combination of volatile memory and nonvolatile memory. In addition, the storage unit 520 provides the stored data at the request of the controller 530.

The controller 530 controls the overall operation of the UE. For example, the controller 530 transmits/receives signals through the communication unit 510. In addition, the controller 530 records data in the storage unit 520 and reads the data from the storage unit 520. In addition, the controller 530 may perform functions of protocol stacks required by communication specifications. To this end, the controller 530 may include at least one processor or microprocessor, or may be a part of a processor. In addition, a part of the communication unit 510 and the controller 530 may be referred to as a communication processor (CP). According to various embodiments, the controller 530 may control the UE to perform operations according to various embodiments as described below.

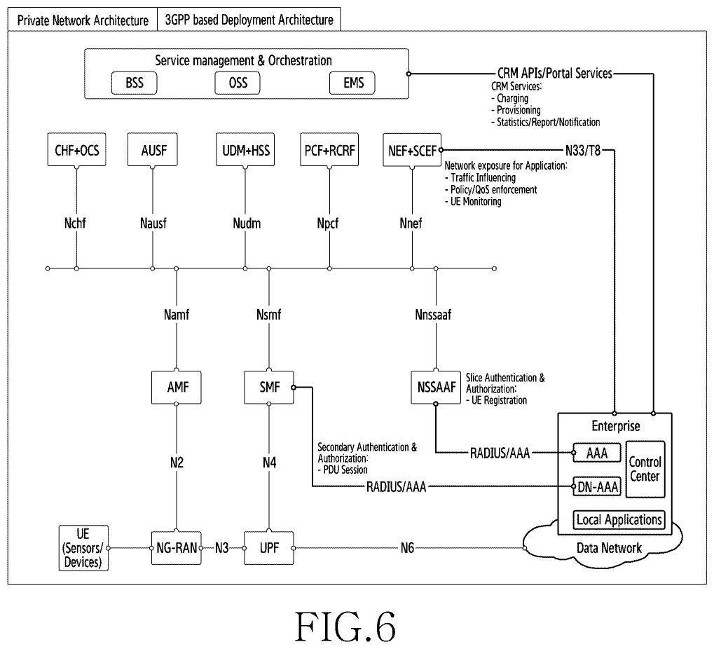

FIG. 6 illustrates a structure of an enterprise private network according to an embodiment of the disclosure.

Referring to FIG. 6, an embodiment of a 3GPP standard-based enterprise private network structure may be described. From the perspective of NE or NF, the configuration of NEs or NFs in a public communication network serving millions of or tens of millions of subscribers and that of an enterprise network serving around one hundred users may be very similar. Therefore, it may be difficult to distinguish between a public communication network and an enterprise network based solely on a network logical diagram, in which only functions without considering scale are illustrated. The enterprise private network may include at least one of an authentication, authorization, and accounting (AAA), a data network (DN)-AAA, local applications, or a control center.

The enterprise private network may be connected to service management and orchestration, which includes business support systems (BSS), operating support system (OSS), and element management system (EMS), via customer relationship management (CRM) application programming interfaces (APIs), and a plurality of portal services may be provided. The provided services (e.g., CRM services) may include at least one of charging, provisioning, statistics, reporting, or notification services. The enterprise private network may be connected to a network exposure function (NEF) and a service capability exposure function (SCEF) via N33/T8 interfaces, and the network exposure functions for applications may provide at least one of traffic influencing, policy/quality of service (QOS) enforcement, or UE monitoring services. The AAA of the enterprise private network may be connected to a network slice-specific authentication and authorization function (NSSAAF) via a RADIUS/AAA interface and may provide slice-level authentication and authorization services for UE registration. The DN-AAA of the enterprise private network may be connected to an SMF via a RADIUS/AAA interface and may provide secondary authentication and authorization services for protocol data unit (PDU) sessions.

When examining the aforementioned structure of the enterprise private network, it may be understood that the deployment of multiple NEs or NFs defined in the 3GPP standard is required to construct the enterprise private network. However, although the construction of an enterprise private network is intended to provide user services and data paths through the network and to provide operational functions, not all functions defined in the 3GPP standard may necessarily be required due to the nature of an enterprise private network. It may be sufficient for the enterprise private network to provide only a portion of functions defined in the 3GPP standard, depending on the requirements of the enterprise. Therefore, from the perspective of a small-scale enterprise, applying all of the NEs or NFs defined in the 3GPP standard may impose a significant burden in terms of cost and operation.

Therefore, enterprise private networks may be constructed, deployed, and operated differently from public networks depending on the service provider's scale, network structure, installation environment/platform, operational characteristics, and operational experience. Users and applications in enterprise private networks may have unique requirements for network services in terms of flexibility and reliability. However, the specialized requirements of enterprise service providers may increase the resource configuration and operation and maintenance (O&M) complexity of existing solutions that are designed based on business-to-consumer (B2C) customers. In particular, enterprise private networks may be critically important in business-to-business (B2B) industrial use cases such as connected vehicles, smart factories, remote healthcare, time-sensitive communications, cellular Internet of Things (IoT), mission-critical IoT, and 5G-local area network (LAN) services. However, supporting the above functions may increase the dependency on 3GPP network functions such as NEF/SCEF, policy control function (PCF)/policy and charging rules function (PCRF), AAA servers, or dedicated network management platforms (OSS/BSS/EMS). Therefore, customized and optimized network solutions may be required to reduce overhead costs in traditional 4G or 5G core networks, such as PCF/PCRF, NEF/SCEF, OSS/BSS, and the like. In order to reduce cost and operational overhead in enterprise private networks, new approaches may be necessary, including establishing new mechanisms or introducing, to a core network, new functions that optimize overall resource utilization to prevent resource leakage and fragmentation, in addition to managing individual flows or service functions. Furthermore, by optimizing network resource usage through such new approaches, capital investment required by enterprises may be minimized.

The disclosure defines a secure network abstraction function (SNAF) that can support the deployment of enterprise private networks by redefining the solution architecture and optimizing the current solution design to support NE/NF deployment from the perspective of minimizing network resource usage. Furthermore, the disclosure proposes a method of applying the newly defined SNAF to a 5G network.

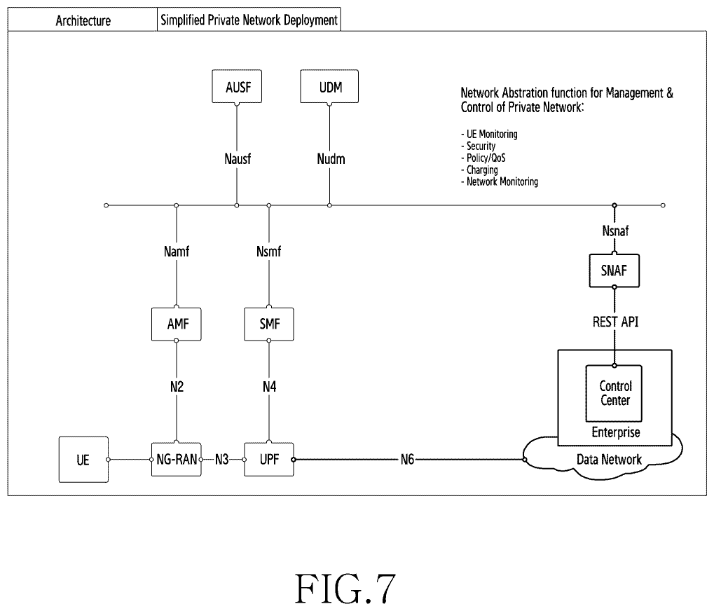

FIG. 7 illustrates the structure of an enterprise private network according to an embodiment of the disclosure.

Referring to FIG. 7, a simplified deployment architecture of an enterprise private network including SNAF may be described. The SNAF may include at least one of the following functions required by enterprises utilizing enterprise private networks.
Dynamic policy enforcement functions specialized for services (e.g., QoS, rate control and the like) without using PCF/PCRF
Real-time traffic usage monitoring and control function. The need for a charging function may be eliminated by the real-time traffic usage monitoring and control function.
Function of exposing network services (e.g., group management, location, monitoring, security, etc.) to external networks without using NEF/SCEF
Function of operating and monitoring (performance/alarm) enterprise private networks without using NMS/OSS;
Basic automation functions for specific event analysis and reporting (based on performance/fault events).

The SNAF, which includes at least one of the aforementioned functions, may provide a service based interface (SBI) (e.g., an Nsnaf interface) to the 5G NFs in order to interwork (or connect) with the 5G NFs for enterprise private networks. Further, the SNAF may provide a REST API to application servers (e.g., control centers) for enterprise private network operators located in the data network. In an embodiment, in relation to the additional 5G NFs shown in the network architecture of FIG. 6 (e.g., at least one of CHF+OCS, PCF+PCRF, NEF+SECF, NSSAAF, or service management & orchestration), only the minimum functions for the enterprise private network operator may be extracted and provided by the SNAF.

However, the aforementioned functions of the SNAF are merely illustrative configurations of the SNAF, and the configuration of the SNAF is not limited to the five functions described above. Accordingly, the SNAF may be flexibly configured to perform at least one function according to the requirements of enterprises using enterprise private networks. For example, the SNAF may include all or some of the five functions described above depending on the requirements of enterprises using enterprise private network, or may be configured to perform functions other than the five functions described above.

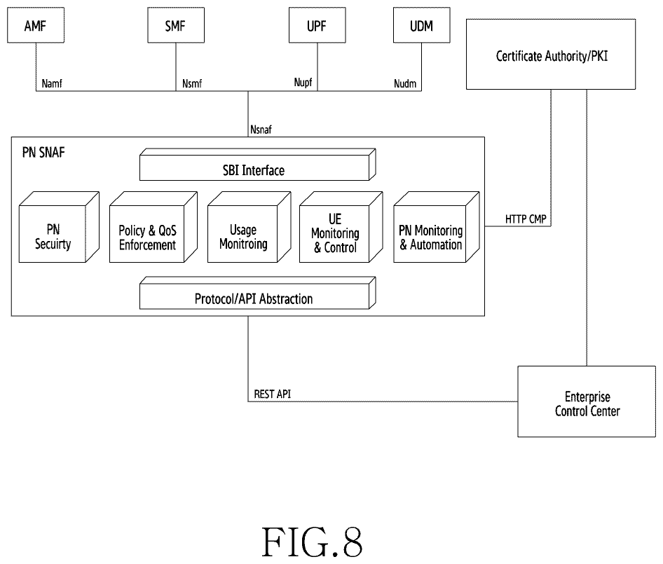

FIG. 8 illustrates an internal structure and interfaces of the SNAF according to an embodiment of the disclosure.

Referring to FIG. 8, the structure of the SNAF, which includes a plurality of functions required by enterprises using enterprise private networks as described in FIG. 7, may be explained. The SNAF may be configured by five internal control blocks and an external interworking block (interface block) to provide the plurality of functions described above. The internal control blocks may be configured as follows.
PN security block, which is responsible for interworking (or connection) with an external certificate authority (CA)/public key infrastructure (PKI) that can manage transport layer security (TLS) certificates for subscribers of the enterprise private network and perform additional authentication/authorization.
Policy & QoS enforcement block, which is a block that applies on-demand or real-time policies to the enterprise private network by using open APIs, and performs QoS control in units of service providers or services.
Usage monitoring block, which is a block that performs monitoring of data usage information. Since the charging function may be optional when deploying the enterprise private network, instead of installing a 3GPP-based charging system, the enterprise private network may use the SNAF API to monitor data usage.
UE monitoring & control block, which is block that performs status management and control for UEs.
PN monitoring & automation block, which is a block that manages the status of resources in the enterprise private network and performs automated control. The PN monitoring & automation block may provide observability for network performance and monitoring, and may enable automation.

The SBI interface block and the protocol/API abstraction block may be used for protocol abstraction between the enterprise private network domain and the control center of the enterprise. The SBI interface block may be used for interworking with 3GPP NFs, and the protocol/API abstraction block may be used for interworking (or connection) with the control center server for enterprise services. In addition, the SNAF may interwork with (or connect to) an external certificate authority (CA/PKI) based on the hypertext transfer protocol (HTTP) certificate management protocol (CMP).

However, the configuration of the SNAF including the five internal control blocks is merely an configuration that may include the plurality of functions shown in FIG. 7, and is not limited to having the five internal control blocks. Accordingly, the SNAF may be flexibly configured depending on the plurality of functions required by enterprises using the enterprise private network. For example, the SNAF may be configured to include all or part of the five internal control blocks described above, depending on the a plurality of functions required by enterprises using the enterprise private network, or may include other internal control blocks capable of performing functions different from those of the five internal control blocks described above.

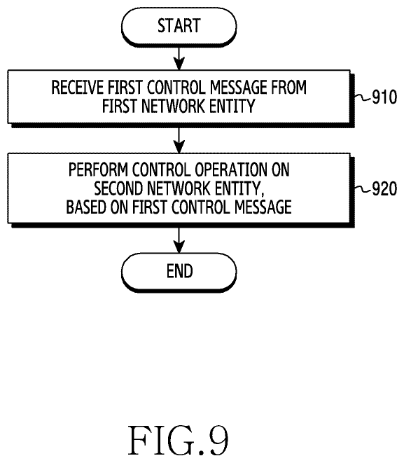

FIG. 9 illustrates a basic operational sequence of the SNAF according to an embodiment of the disclosure.

Referring to FIG. 9, the basic operational sequence of the SNAF, which includes at least one internal control block as described in FIG. 8, may be explained below.

In operation 910, the SNAF may receive a first control message from a first network entity. In this case, the SNAF may perform a portion of the functions of a 5GC network between network entities of the 5GC and a control center of the enterprise. Accordingly, the first network entity may be the control center of the enterprise. Further, the SNAF may interwork with (or connect to) the first network entity via a predetermined interface (e.g., a REST API). The first control message received from the first network entity may include at least one piece of information for controlling a second network entity. The at least one piece of information that may be included in the first control message may differ depending on the type of control operation. Hereinafter, in embodiments of the disclosure, at least one piece of information included in the first control message according to each control operation will be specifically described.

In operation 920, the SNAF may perform a control operation on the second network entity, based on the first control message received from the first network entity. The second network entity may be at least one of the network entities of the 5GC network, and may be a network entity that transmits and/or receives a plurality of signals to and from the first network entity via the SNAF. The control operation based on the first control message may be an operation for performing functions according to the requirements of the enterprise. For example, the control operation may refer to at least one of, a certificate acquisition/distribution procedure, a subscriber access control procedure, a session setup authorization procedure, a policy and QoS control procedure, a usage monitoring procedure, a UE state monitoring procedure, or a private network monitoring procedure, as illustrated in FIG. 7.

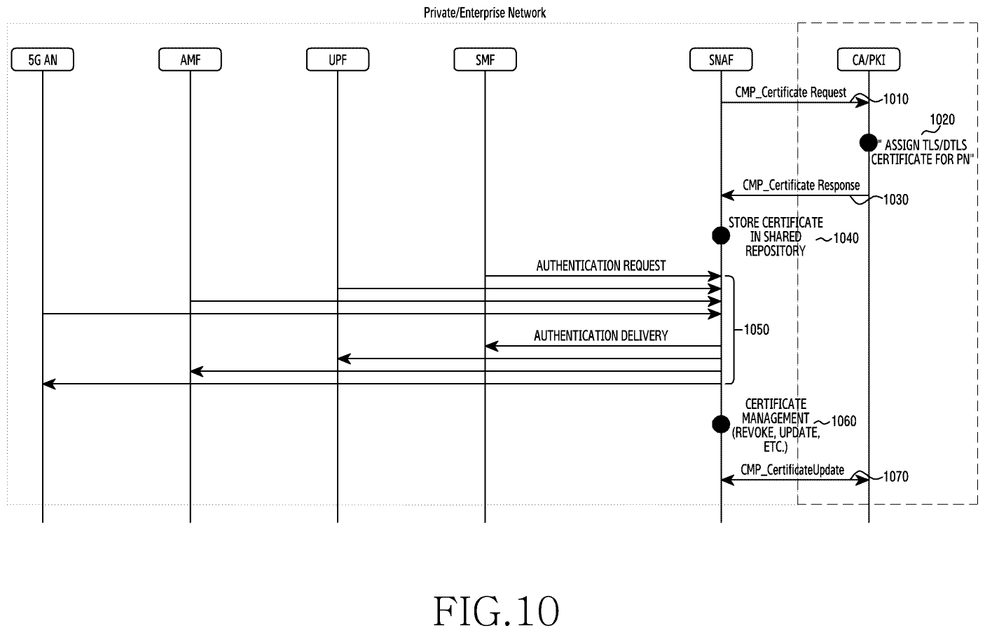

FIG. 10 illustrates a signal flow in a SNAF-based certificate acquisition and delivery procedure according to an embodiment of the disclosure.

Referring to FIG. 10, a certificate (or authentication) acquisition and delivery procedure based on the SNAF may be described. The SNAF may support a CMP and acquire certificates for each 5GC NF and 5G access network (AN) by interworking with CA/PKI of an external public network. The SNAF may then deliver the acquired certificates to the respective 5GC NFs and 5G ANs. In addition, the SNAF may support certificate management functions. For example, the SNAF may perform certificate revocation or update. Furthermore, the SNAF may perform a certificate acquisition procedure (e.g., GET Certificates) and a certificate delivery procedure (e.g., PUT Certificates) with each NF of 5GC via SBI (e.g., Nsnaf interface) in the 5GC NF and 5G AN. The certificate acquisition and delivery procedure based on the SNAF may specifically include the following.

In operation 1010, the SNAF may initiate the certificate acquisition procedure by transmitting a certificate request message (e.g., CMP_Certificate request) to the CA/PKI.

In operation 1020, the CA/PKI may assign a certificate in response to a request of the SNAF. For example, the CA/PKI may obtain certificates for multiple NFs through a single transaction, or obtain certificates for each NF through separate transaction for each NF.

In operation 1030, the SNAF may receive a certificate response message (e.g., CMP_Certificate response) including a certificate from the CA/PKI. The certificate response message may include at least one of a certificate and certificate assignment information.

In operation 1040, the SNAF may store the information included in the certificate response message in a repository (e.g., a shared repository). Accordingly, the repository may store at least one of the certificate and the certificate assignment information.

In operation 1050, upon receiving a certificate request message from a 5GC NF (e.g., at least one of a 5G AN, AMF, UPF, and SMF), the SNAF may transmit (or deliver) the requested certificate to the corresponding NF that has transmitted the certificate request message. For example, the SNAF may receive an authentication request message from the 5GC NF (e.g., at least one of 5G AN, AMF, UPF, and SMF), and may, in response to the certificate request message, transmit (or deliver) a certificate to each 5GC NF that has transmitted the authentication request message.

In operation 1060, the SNAF may perform a certificate management operation for the certificate stored in the repository. For example, the certificate management operation may include revoking or updating the stored certificate.

In operation 1070, the SNAF may monitor the validity period of the certificate. When the stored certificate is updated in operation 1060, the SNAF may transmit the updated certificate to the CA/PKI.

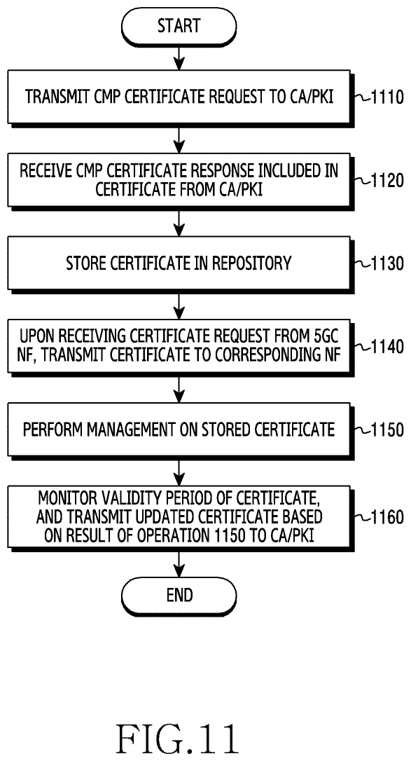

FIG. 11 illustrates a sequence of SNAF-based certificate acquisition and delivery according to an embodiment of the disclosure.

Referring to FIG. 11, an operational sequence of a SNAF in the SNAF-based certificate acquisition and delivery procedure described in FIG. 10 may be explained.

In operation 1110, the SNAF may initiate a certificate acquisition procedure by transmitting a certificate request message (e.g., CMP_Certificate request) to the CA/PKI.

In operation 1120, the SNAF may receive a certificate response message (e.g., CMP_Certificate response) from the CA/PKI. The certificate response message may include at least one of certificate assignment information or a certificate assigned by the CA/PKI.

In operation 1130, the SNAF may store the information included in the certificate response message in a repository. Accordingly, at least one of the certificate or certificate assignment information may be stored in the repository.

In operation 1140, upon receiving a certificate request from a 5GC NF (e.g., at least one of a 5G AN, AMF, UPF, and SMF), the SNAF may transmit (or deliver) the requested certificate to the corresponding NF. For example, the SNAF may receive an authentication request message from the 5GC NF (e.g., 5G AN, AMF, UPF, and SMF), and may, in response to the certificate request message, transmit (or deliver) a certificate to each 5GC NF that has transmitted the authentication request message.

In operation 1150, the SNAF may perform a management operation on the certificate stored in the repository. For example, the management operation on the certificate may include revoking or updating the stored certificate.

In operation 1160, the SNAF may monitor the validity period of the certificates. When the stored certificate is updated in operation 1150, the SNAF may transmit the updated certificate to the CA/PKI.

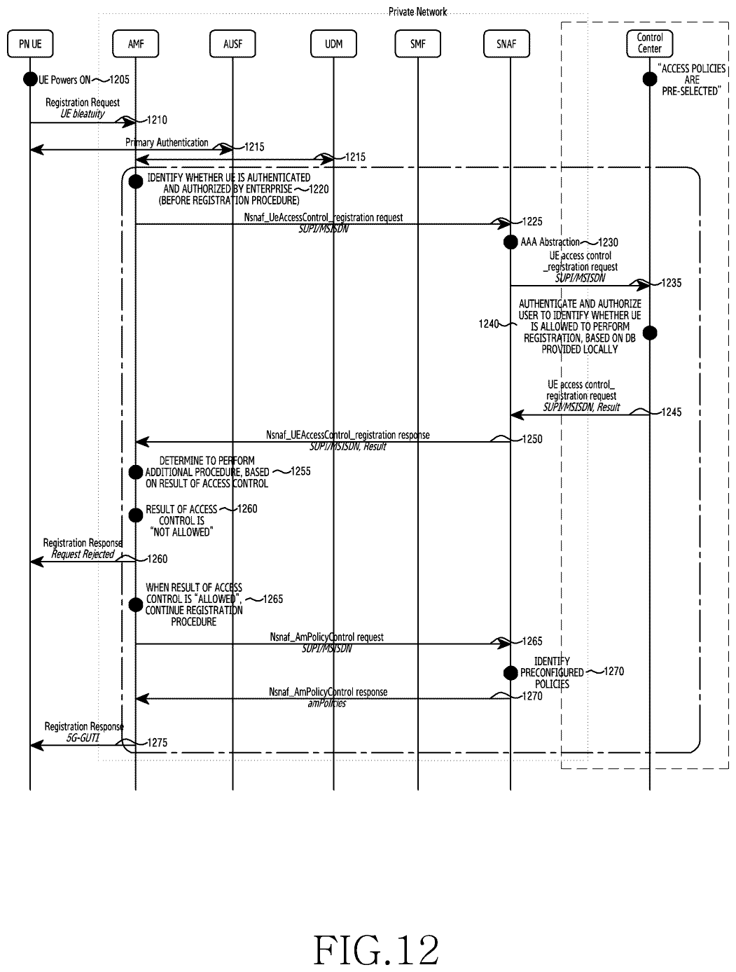

FIG. 12 illustrates a signal flow in a SNAF-based subscriber access control procedure according to an embodiment of the disclosure.

Referring to FIG. 12, after the authentication process provided by the 5G network is successful in an enterprise private network employing the SNAF, a user authentication process via the control center of the enterprise private network may be explained. A UE may perform a registration process to establish connectivity with the communication network after being powered on. In this case, the UE may refer to a terminal that utilizes an enterprise private network or receives services from the enterprise private network. During the registration process, the UE may perform mutual authentication with the network. From the perspective of the UE, the registration and authentication procedure may serve to identify whether the network supports the UE's subscription. From the network perspective, the registration and authentication process may be a procedure of identifying that the UE attempting to access the network is subscribed to the services provided by the network. The aforementioned registration and authentication process may be the same or similar to the registration and authentication procedure defined in the 3GPP standard.

In addition, in the case of a UE using services of an enterprise private network, an authorization procedure for the enterprise private network services may be performed by default. Accordingly, if the AMF is a dedicated AMF for the enterprise private network, a service authorization procedure may need to be performed for all UEs performing registration. The AMF that accommodates both multiple service providers or public service subscribers and enterprise private network service subscribers may determine whether to perform the service authorization procedure by identifying the subscriber type or service type (e.g., a slice identifier (ID)).

When it is determined whether to perform the service authorization procedure, the AMF may transmit an access control registration request message for the UE (e.g., Nsnaf_UeAccessControl_registration request) to the SNAF. Since the SNAF is an entity responsible for performing the service authorization procedure for the UE for an enterprise private network, the SNAF may have an access policy for the UE according to a preconfigured condition. The access policy may include address information of a control center of the private network for the UE and configuration information indicating whether access control is to be performed.

When the access policy is configured to perform access control via the control center, the SNAF may transmit a UE access control registration request message (e.g., UE Access Control_registration request) to the control center of the enterprise private network and perform an access control operation, and may deliver the result of the access control operation (e.g., at least one of “ALLOWED” or “NOT ALLOWED”) to the AMF. The AMF may perform the remaining registration procedure according to the information (e.g., the result of performing the access control operation) that has been delivered from the SNAF.

Specifically, the registration procedure of a 5G communication system, including access control to the control center of the enterprise private network, may be described as follows. The registration procedure in this embodiment of the disclosure may be explained under an assumption that access control policies for UEs of the enterprise private network are preconfigured in the SNAF.

In operation 1205, when the UE is powered on, the registration and authentication procedure of the UE may be initiated.

In operation 1210, the UE may transmit a registration request message to the AMF to perform the registration procedure. The registration request message may include an identifier of the UE (e.g., UE ID).

In operation 1215, a primary authentication procedure may be performed. Accordingly, signals required for authentication procedures between the UE and the AUSF, and between the AMF and the UDM may be transmitted and/or received. The authentication procedure in operation 1215 may be identical or similar to a 3GPP-based 5G authentication procedure.

In operation 1220, the AMF may perform the UE access control for the UE using the enterprise private network. Therefore, the AMF may identify whether the UE is authenticated and authorized by the enterprise before performing the registration procedure.

In operation 1225, the AMF may transmit a registration request message for UE access control (e.g., Nsnaf_UeAccessControl_Registration request) to the SNAF. The registration request message may include at least one of a subscription permanent identifier (SUPI) or mobile station integrated digital network (MSISDN).

In operation 1230, based on the access control policy for the UE, the SNAF may determine that authentication and authorization by the control center is required. Here, the determination by the SNAF as to whether authentication and authorization is required may be referred to as an AAA abstraction operation.

In operation 1235, the SNAF may transmit a registration request message for UE access control (e.g., UEAccess control_registration request) to the control center. Similar to the registration request message that has been received from the AMF in operation 1225, the registration request message of operation 1235 may include at least one of the SUPI or MSISDN. However, the interface used for signaling each message may differ.

In operation 1240, the control center may perform an authentication and authorization procedure for the UE. For example, the authentication and authorization procedure may be a procedure of identifying whether the UE is allowed to perform registration, based on a database provided locally to the control center.

In operation 1245, the control center may transmit a message (e.g., UE access control_registration response) including the result of the UE access control (e.g., the result of performing the authentication and authorization procedure) to the SNAF. The message including the result of the UE access control may include at least one of the result of performing the authentication and authorization procedure for the UE in operation 1240, the SUPI, or the MSISDN. In this case, the result of performing the authentication and authorization procedure for the UE may be at least one of “ALLOWED” or “NOT ALLOWED.”

In operation 1250, the SNAF may transmit a message including the result of UE access control (e.g., Nsnaf_UeAccessControl_registration response) received from the control center to the AMF. The message including the result of UE access control received from the control center may include at least one of the result of performing the authentication and authorization procedure for the UE in operation 1240, the SUPI, or the MSISDN.

In operation 1255, based on the result of performing the UE access control, the AMF may determine to perform an additional procedure.

In operation 1260, when the result of performing the access control for the UE is “NOT ALLOWED,” the AMF may transmit a registration response message to the UE. The registration response message may include a rejection of the request (e.g., the registration request in operation 1210).

In operation 1265, when the result of performing the access control for the UE is “ALLOWED,” the AMF may transmit an access and mobility (AM) policy control request message (e.g., Nsnaf_AmPolicyControl request) to the SNAF. The AM policy control request message may include at least one of the SUPI or MSISDN.

In operation 1270, the SNAF may identify preconfigured AM policies. Further, the SNAF may transmit an AM policy control response message (e.g., Nsnaf_AmPolicyControl response) to the AMF. The AM policy control response message may include AM policies.

In operation 1275, the AMF may transmit a registration request message including a 5G-globally unique temporary identifier (GUTI) to the UE.

Operations 1220 to 1280 described above may include operations different from those in the 3GPP-based 5G registration and authentication procedure and may be newly defined as operations to support enterprise private networks including the SNAF.

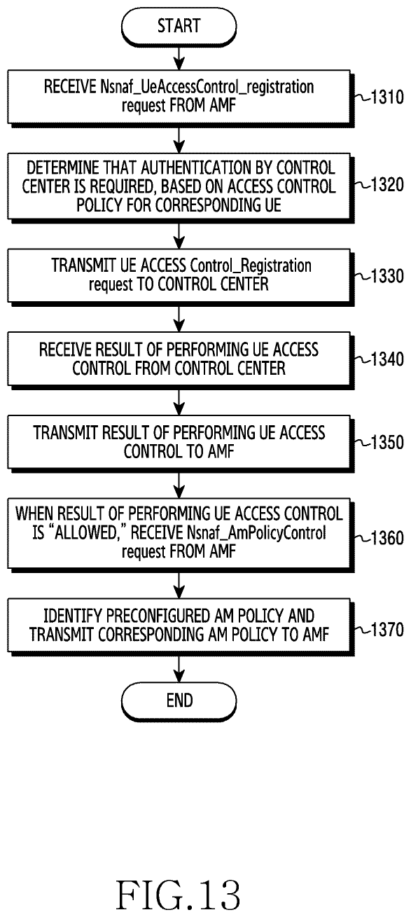

FIG. 13 illustrates a sequence of SNAF-based subscriber access control according to an embodiment of the disclosure.

Referring to FIG. 13, the operational sequence of the SNAF in the subscriber access control procedure, which has been described above with reference to FIG. 12, may be explained.

In operation 1310, the SNAF may receive a registration request message for UE access control (e.g., Nsnaf_UeAccessControl_registration request) from the AMF. The registration request message may include at least one of a SUPI or MSISDN.

In operation 1320, based on the access control policy for the UE, the SNAF may determine that authentication and authorization by the control center are required. The determination by the SNAF as to whether authentication and authorization is required may be referred to as an AAA abstraction operation.

In operation 1330, the SNAF may transmit a registration request message for UE access control (e.g., UE access control_registration request) to the control center. Similar to the registration request message that has been received from the AMF in operation 1310, the registration request message of operation 1330 may include at least one of a SUPI or MSISDN. However, the interface used for signaling each message may differ.

In operation 1340, the SNAF may receive a message including the result of performing the access control for the UE (e.g., UE Access control_registration response) from the control center. The message including the result of performing the access control for the UE may include at least one of the result of the authentication and authorization procedure for the UE, the SUPI, or the MSISDN. The result of performing the authentication and authorization procedure for the UE may be at least one of “ALLOWED” or “NOT ALLOWED.”

In operation 1350, the SNAF may transmit, to the AMF, the message including the result of performing the access control for the UE (e.g., Nsnaf_UeAccessControl_registration response) that has been received from the control center. The message including the result of performing the access control for the UE that has been received from the control center may include at least one of the result of the authentication and authorization procedure for the UE, the SUPI, or MSISDN.

In operation 1360, when the result of performing the access control for the UE operation is “ALLOWED,” the SNAF may receive an AM policy control request message (e.g., Nsnaf_AmPolicyControl request) from the AMF. The AM policy control request message may include at least one of the SUPI or MSISDN.

In operation 1370, the SNAF may identify preconfigured AM policies. Additionally, the SNAF may transmit an AM policy control response message (e.g., Nsnaf_AmPolicyControl response) to the AMF. The AM policy control response message may include the AM policies.

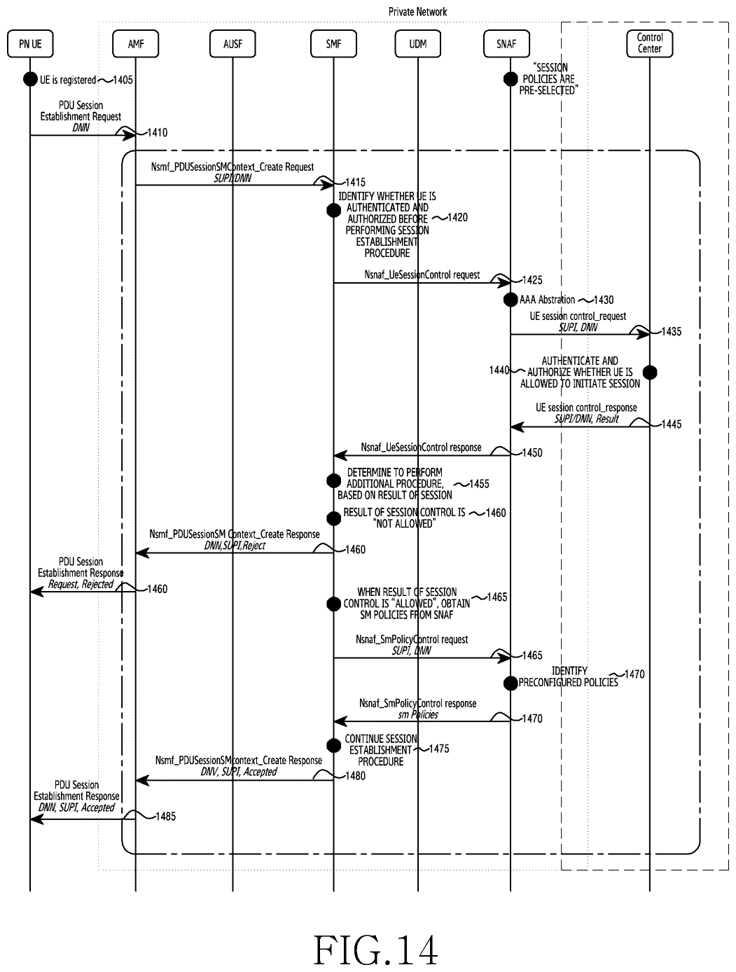

FIG. 14 illustrates a signal flow in a SNAF-based session authorization procedure according to an embodiment of the disclosure.

Referring to FIG. 14, a session authorization procedure in an enterprise private network employing the SNAF may be explained. Even when setting up a session in the enterprise private network, an authorization function for session setup may be required. The authorization function may be required not only for simply subscribing to enterprise services, but also for purposes such as capacity and management of the enterprise network. The SNAF does not directly perform the authorization procedure, but may request authentication from an enterprise control center located outside the 3GPP network. The control center may be responsible for executing authorization policies.

In order to perform the session authorization procedure, the SNAF may have the session policy through a local configuration. In addition, the SMF, which performs session control within the 5GC, may transmit a session control request of the UE to the SNAF. The overall process may be described as follows. The session establishment procedure of this embodiment of the disclosure may be explained under an assumption that session policies for UEs of the enterprise private network are preconfigured in the SNAF.

In operation 1405, the UE is already registered in the 5GC network, and based on this registration, the session authorization procedure may be initiated.

In operation 1410, the UE may transmit a PDU session establishment request message to the SMF in order to perform the session establishment procedure. The PDU session establishment request message may include a data network name (DNN). The transmission of the PDU session establishment request message in operation 1410 may include a procedure which is the same as or similar to the transmission procedure of the PDU session establishment request message based on 3GPP.

In operation 1415, the AMF may transmit, to the SMF, a session establishment request message (e.g., Nsmf_PDUSessionSMContext_Create request) for a PDU session corresponding to the PDU session establishment request received from the UE. The session establishment request message for the PDU session corresponding to the PDU session establishment request received from the UE may include at least one of a SUPI and a DNN.

In operation 1420, the SMF may determine that UE session policy control is to be performed for the UE using the enterprise private network. Accordingly, the SMF may identify whether the UE has been authenticated and authorized before performing the session establishment procedure.

In operation 1425, the SMF may transmit a session policy control request message (e.g., Nsnaf_UeSessionControl request) to the SNAF. The session policy control request message may include at least one of the SUPI or DNN.

In operation 1430, based on the session policies for the UE, the SNAF may determine that authentication and authorization by the control center are required. Here, the determination by the SNAF as to whether authentication and authorization is required may be referred to as an AAA abstraction operation

In operation 1435, the SNAF may transmit a session control request message for the UE (e.g., UE session control_request) to the control center. Similar to the session policy control request message that has been received from the SMF in operation 1425, the session control request message of operation 1435 may include at least one of the SUPI or DNN. However, the interface used for signaling each message may differ.

In operation 1440, the control center may perform the authentication and authorization procedure for the UE. For example, this authentication and authorization procedure may involve determining whether the UE is allowed to initiate the session.

In operation 1445, the control center may transmit a message (e.g., UE session control_response) including the result of performing the session control (e.g., the result of performing the authentication and authorization procedure for the UE) to the SNAF. The message including the result of performing the session control for the UE may include at least one of the result of performing the authentication and authorization procedure for the UE in operation 1440, a SUPI, or a DNN. In this case, the result of performing the authentication and authorization procedure for the UE may be at least one of “ALLOWED” or “NOT ALLOWED.”

In operation 1450, the SNAF may transmit, to the SMF, a message including the result of performing the session control for the UE (e.g., Nsnaf_UeSessionControl response) received from the control center. The message including the result of performing the session control for the UE that has been received from the control center may include at least one of the result of performing the authentication and authorization procedure for the UE in operation 1440, a SUPI, or a DNN.

In operation 1455, based on the result of performing the session control for the UE, the SMF may determine to perform an additional procedure.

In operation 1460, when the result of performing the session control for the UE is “NOT ALLOWED,” the SMF may transmit, to the AMF, a response message (e.g., Nsmf_PDUSessionSMContext_Create response) for the PDU session establishment request, as a response to the message that has been received in operation 1415. The response message may include a SUPI, a DNN, or a rejection for the request (e.g., the registration request of operation 1415). In addition, the AMF may transmit, to the UE, a PDU session establishment response message including a rejection for the request (e.g., the registration request of operation 1415).

In operation 1465, when the result of performing the session control for the UE is “ALLOWED”, the SMF may obtain session and mobility (SM) policies from the SNAF. In addition, the SMF may transmit an SM policy control request message (e.g., Nsnaf_SmPolicyControl request) to the SNAF. The SM policy control request message may include at least one of the SUPI or the DNN.

In operation 1470, the SNAF may identify pre-configured SM policies. Further, the SNAF may transmit an SM policy control response message (e.g., Nsnaf_SmPolicyControl response) to the SMF. The SM policy control response message may include SM policies.

In operation 1475, the SMF may proceed with the session establishment procedure.

In operation 1480, the SMF may transmit, to the AMF, a response message (e.g., Nsmf_PDUSessionSMContext_Create response) for the PDU session establishment request, as a response to the message that has been received in operation 1415. The response message may include SUPI, DNN, or acceptance of the request (e.g., registration request of operation 1415).

In operation 1485, the AMF may transmit, to the UE, a PDU session establishment response message including SUPI, DNN, or rejection of the request (e.g., registration request of operation 1415).

Operations 1415 to 1480 described above may include other operations than the 3GPP-based session establishment procedure and may be newly defined as operations to support enterprise private networks including the SNAF.

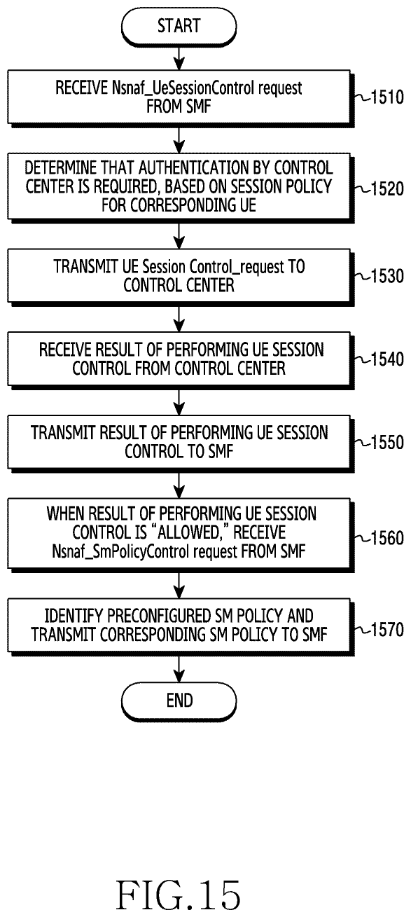

FIG. 15 illustrates a sequence of SNAF-based session authentication according to an embodiment of the disclosure.

Referring to FIG. 15, the operational sequence of the SNAF in the SNAF-based session authorization procedure, which has been described with reference to FIG. 14, may be explained. In this embodiment of the disclosure, the session establishment procedure may be explained under an assumption that session policies for UEs of the enterprise private network are preconfigured in the SNAF.

In operation 1510, the SNAF may receive a session policy control request message (e.g., Nsnaf_UeSessionControl request) from the SMF. The session policy control request message may include at least one of SUPI or DNN.

In operation 1520, based on the session policies for the UE, the SNAF may determine that authentication and authorization by the control center is required. The determination by the SNAF as to whether authentication and authorization is required may be referred to as an AAA abstraction operation.

In operation 1530, the SNAF may transmit a session control request message for the UE (e.g., UE session control_request) to the control center. Similar to the session policy control request message that has been received from the SMF in operation 1510, the session control request message of operation 1530 may include at least one of SUPI or DNN. However, the interface used for signaling each message may differ.

In operation 1540, the SNAF may receive, from the control center, a message (e.g., UE session control_response) including the result of performing the session control (e.g., the result of the authentication and authorization procedure for the UE). The message including the result of performing the session control for the UE may include at least one of the result of performing the authentication and authorization procedure for the UE, a SUPI, or a DNN. In this case, the result of performing the authentication and authorization procedure for the UE may be at least one of “ALLOWED” or “NOT ALLOWED.”

In operation 1550, the SNAF may transmit, to the SMF, the message including the result of performing the session control for the UE (e.g., Nsnaf_UeSessionControl_response) received from the control center. The message including the result of performing the session control for the UE received from the control center may include at least one of the result of performing the authentication and authorization procedure for the UE, a SUPI, or a DNN.

In operation 1560, when the result of performing the session control for the UE is “ALLOWED,” the SNAF may provide SM policies to the SMF. In this case, the SNAF may receive an SM policy control request message (e.g., Nsnaf_SmPolicyControl request) from the SMF. The SM policy control request message may include at least one of a SUPI or a DNN.

In operation 1570, the SNAF may identify the preconfigured SM policies. Further, the SNAF may transmit an SM policy control response message (e.g., Nsnaf_SmPolicyControl response) to the SMF. The SM policy control response message may include SM policies.

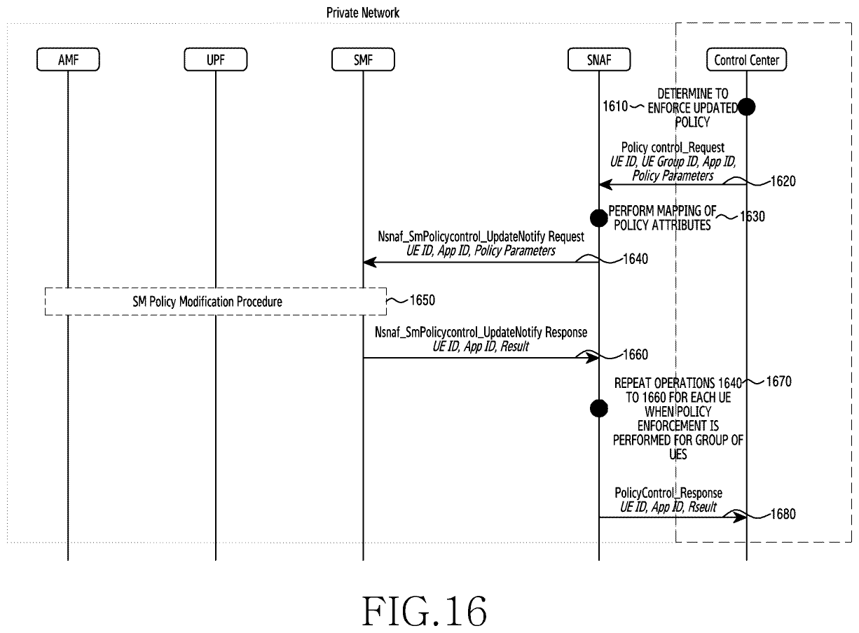

FIG. 16 illustrates a signal flow in a SNAF-based policy and QoS procedure according to an embodiment of the disclosure.

Referring to FIG. 16, the policy and QoS procedure in an enterprise private network employing the SNAF may be explained. Due to the nature of the enterprise private network, it may be more common for policies designated by the enterprise service provider to be applied across the entire network, rather than subscriber-level policies. In this case, the policy information designated by the enterprise service provider may not include identifier information (e.g., UE ID) for individual UEs. However, if the policy information includes identifiers for individual UEs, the policy update procedure may be performed only for the corresponding UE.

When an enterprise service provider needs to change a QoS policy for a specific service, a control center of the enterprise located outside the 3GPP network may transmit a policy control request to the SNAF so as to deliver the changed policy information. In order to apply the changed QoS policy, the SNAF may provide an API to the outside of the 3GPP network to support enabling the external enterprise control center to control services provided within the 3GPP network. The SNAF may convert the policy control request transmitted from outside the 3GPP network into policy attributes conforming to the 3GPP network, and deliver the same to the SMF. The SMF may perform control over sessions within the enterprise private network, thereby applying the changed policy to individual UEs in the enterprise private network.

Due to the nature of enterprise services, an enterprise may change a QoS policy only for UEs belonging to a specific group. In this case, the enterprise control center may deliver only the identifiers of UEs belonging to the specific group to the SNAF, and SNAF may change the QoS policy for individual UEs within the group. In order to change the QoS policy for UEs belonging to the aforementioned specific group, the SNAF may also need to provide management functions for service-specific groups and group members.

The policy and QoS control procedure by the SNAF may be specifically described as follows.

In operation 1610, the enterprise service provider may determine to enforce the changed policy.

In operation 1620, the control center of the enterprise service provider outside the 3GPP network may transmit a policy control request message (e.g., Policy Control_request) to the SNAF. The policy control request message may include at least one of a UE identifier, a UE group identifier, an application identifier, or policy parameters.

In operation 1630, the SNAF may convert the updated policy received from the enterprise service provider into 3GPP network attributes in order to enforce the updated policy in the 3GPP network. For example, the SNAF may map the information and parameters included in the policy control request message received from the control center so as to conform to the attributes (or definitions) of the 3GPP network.

In operation 1640, the SNAF may transmit the converted policy control request message (e.g., Nsnaf_SmPolicyControl_UpdateNotify request) to the SMF. The converted policy control request message may include at least one of a UE identifier, an application identifier, or policy parameters.

In operation 1650, the SMF may perform a policy update operation for the individual UE.

In operation 1660, the SMF may transmit, to the SNAF, a policy control request response message (e.g., Nsnaf_SmPolicyControl_UpdateNotify response) including the result of proceeding the policy update. The policy control request response message including the result of proceeding the policy update may include at least one of a UE identifier, an application identifier, or the result of policy update.

In operation 1670, when a policy update procedure is performed for a group of UEs through operations 1640 to 1660, the SNAF may repeat operations 1640 to 1660 for each UE belonging to the group in order to perform a policy update for individual UEs belonging to the group.

In operation 1680, when the policy update procedure is completed, the SNAF may transmit a policy control response message (e.g., Policy Control_response) to the control center.

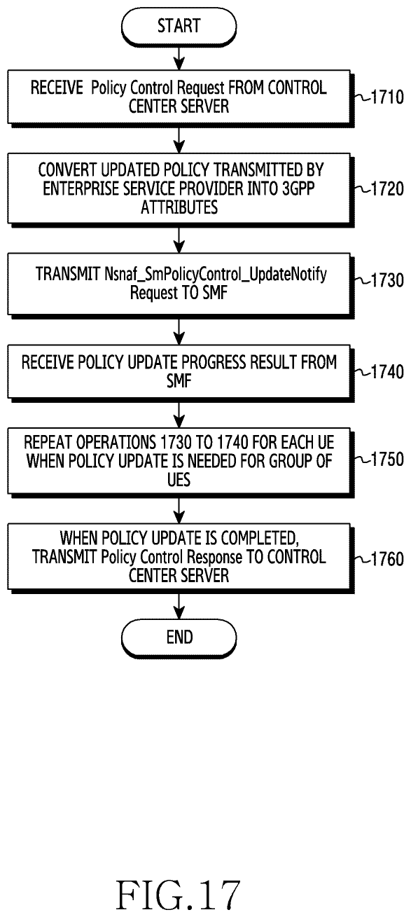

FIG. 17 illustrates a sequence of a SNAF-based policy and QoS procedure according to an embodiment of the disclosure.

Referring to FIG. 17, the operational sequence of the SNAF in the policy and QoS procedure of an enterprise private network employing the SNAF may be explained.

In operation 1710, the SNAF may receive a policy control request message (e.g., Policy_Control_request) from a control center of an enterprise service provider located outside the 3GPP network. The policy control request message may include at least one of a UE identifier, a UE group identifier, an application identifier, or policy parameters.

In operation 1720, the SNAF may convert the updated policy received from the enterprise service provider into 3GPP network attributes in order to enforce the policy in the 3GPP network. For example, the SNAF may map the policy control request message received from the control center so as to conform to the attributes of the 3GPP network.

In operation 1730, the SNAF may transmit the converted policy control request message (e.g., Nsnaf_SmPolicyControl_UpdateNotify request) to the SMF. The converted policy control request message may include at least one of a UE identifier, an application identifier, or policy parameters.

In operation 1740, the SNAF may receive a policy control request response message (e.g., Nsnaf_SmPolicyControl_UpdateNotify response) from the SMF, the message including the result of proceeding the policy update. The policy control request response message including the result of proceeding the policy update may include at least one of a UE identifier, an application identifier, or policy update results.

In operation 1750, when the policy update procedure is performed for a group of UEs, the SNAF may repeat operations 1730 to 1740 for each UE belonging to the group in order to perform a policy update for individual UEs belonging to the group.

In operation 1760, when the policy update procedure is completed, the SNAF may transmit a policy control response message (e.g., Policy_Control_response) to the control center.

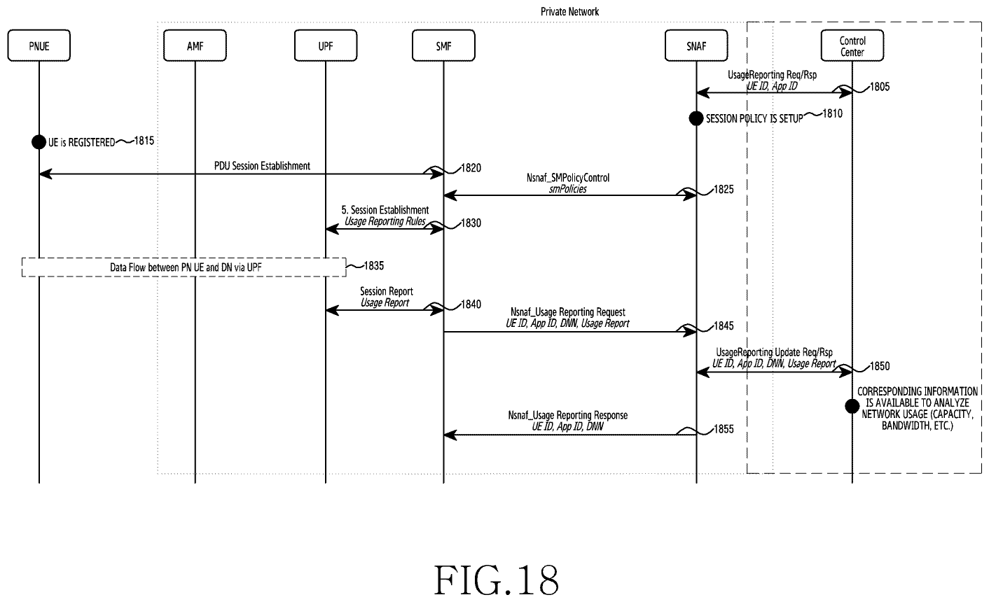

FIG. 18 illustrates a signal flow in in a SNAF-based usage monitoring procedure according to an embodiment of the disclosure.

Referring to FIG. 18, a usage monitoring procedure in an enterprise private network where the SNAF is deployed may be explained. An enterprise service provider using the enterprise private network may need to identify the usage status of the corresponding network resource. The 5G NFs may fulfill the enterprise service provider's need to identify the usage status of network resources through a usage monitoring procedure.

Accordingly, the control center of the enterprise provider may request usage reporting for the 3GPP network from the SNAF. The SNAF may provide APIs to the outside of the 3GPP network to enable the control center of the external network to deliver a control request to the 3GPP network. In response to the request from the control center, the SNAF may configure session policies internally for a target to which usage reporting should be provided. When the UE attempts to establish a PDU session and thus the SMF requests an SM policy from the SNAF, the SNAF may include usage report configuration information in the SM policy and deliver the SM policy to the SMF. The usage report instruction included in the SM policy may be delivered to the UPF. The UPF may perform usage reporting according to usage reporting conditions. The usage report of the UPF may be delivered to the SNAF via the SMF, and the SNAF may transmit the received usage report to the enterprise control center. The aforementioned usage reporting procedure eliminates the need for a dedicated billing system in enterprise private networks. The specific procedure may be as follows.

In operation 1805, the control center of the enterprise service provider outside the 3GPP network may transmit a usage reporting request message (e.g., Usage Reporting request) to the SNAF. The usage reporting request message may include at least one of a UE identifier or application identifier. The SNAF may also receive a usage reporting response message (e.g., usage reporting response) from the control center.

In operation 1810, the SNAF may store the usage reporting request message received from the enterprise service provider as a session policy. For example, the SNAF may have the session policy through a local configuration, and may update a pre-configured session policy when the SNAF receives the usage report request message from the control center.

In operation 1815, the UE may be registered in the enterprise private network.

In operation 1820, a PDU session establishment procedure between the UE and the SMF may be proceeded.

In operation 1825, the SNAF may perform an SM policy control procedure (e.g., a procedure related to Nsnaf_SMPolicyControl) with the SMF. Operations 1420 to 1475 described in FIG. 14 may be performed. Here, information regarding SM policies may be transmitted and/or received between the SMF and the SNAF.

In operation 1830, the SMF may perform a session establishment procedure with the UPF. The SM policy may be applied to the UPF. Information regarding usage reporting rules may be transmitted and/or received between the SMF and UPF.

In operation 1835, the PDU session may be set up for the UE, and user plane (UP) data may be transmitted and/or received between the DN and the UE via the UPF.

In operation 1840, the UPF may transmit, to the SMF, a report message (e.g., session report) regarding the session setup. The report message regarding the session setup may include a usage report.

In operation 1845, the SMF may transmit a usage reporting request message (e.g., Nsnaf_UsageReporting request) to the SNAF. Here, the usage reporting request message may include at least one of a UE identifier, application identifier, DNN, or information regarding usage reporting.

In operation 1850, the SNAF may perform usage reporting to a control center outside the 3GPP network through a usage reporting update request message (e.g., UsageReporting Update request). The usage reporting update request message may include at least one of a UE identifier, application identifier, DNN, or information regarding usage reporting. The SNAF may also receive a usage reporting update request message (e.g., UsageReporting Update response) from the control center. The enterprise that has received information on network resource usage may monitor network resource usage (e.g., capacity, bandwidth, etc.) by using the received information.

In operation 1855, the SNAF may transmit a usage reporting response message (e.g., Nsnaf_UsageReporting response) in response to the usage reporting request message received from the SMF.

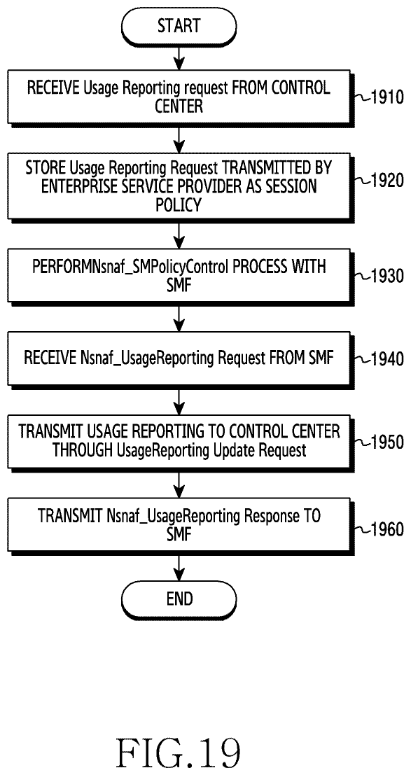

FIG. 19 illustrates a SNAF-based usage monitoring sequence according to an embodiment of the disclosure.

Referring to FIG. 19, an operational sequence of the SNAF in the SNAF-based usage monitoring procedure may be explained.

In operation 1910, the SNAF may receive a usage reporting request message (e.g., Usage Reporting request) from a control center of an enterprise service provider located outside the 3GPP network. The usage reporting request message may include at least one of a UE identifier or an application identifier. In addition, the SNAF may receive a usage reporting response message (e.g., usage reporting response) from the control center.

In operation 1920, the SNAF may store the usage reporting request message received from the enterprise service provider as a session policy. For example, the SNAF may have session policy through a local configuration, and may update the pre-configured session policy when the SNAF receives the usage reporting request message from the control center.

In operation 1930, the SNAF may perform an SM policy control procedure (e.g., a procedure related to Nsnaf_SMPolicyControl) with the SMF. Accordingly, operations 1420 to 1475 described in FIG. 14 may be performed. In this case, information regarding SM policies may be transmitted and/or received between the SMF and the SNAF.

In operation 1940, the SNAF may receive a usage reporting request message (e.g., Nsnaf_UsageReporting request) from the SMF. The usage reporting request message may include at least one of a UE identifier, an application identifier, a DNN, or information regarding usage reporting.

In operation 1950, the SNAF may perform usage reporting to the control center outside the 3GPP network through a usage reporting update request message (e.g., UsageReporting Update request). The usage reporting update request message may include at least one of a UE identifier, an application identifier, a DNN, or information regarding usage reporting. In addition, the SNAF may receive a usage reporting update request message (e.g., UsageReporting Update response) from the control center.

In operation 1960, in response to the usage reporting request message received from the SMF, the SNAF may transmit a usage reporting response message (e.g., Nsnaf_UsageReporting response) to the SMF.

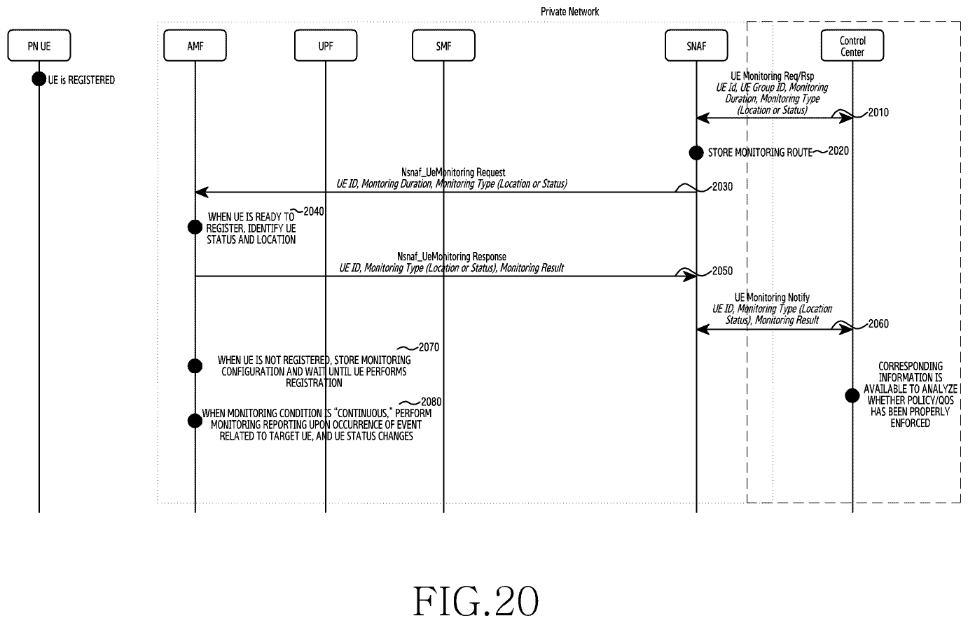

FIG. 20 illustrates a signal flow in a SNAF-based UE status monitoring procedure according to an embodiment of the disclosure.

Referring to FIG. 20, a UE status monitoring procedure in a network in which the SNAF is deployed may be explained. When an enterprise private network is constructed for IoT services, managing the status of devices such as sensors may be critically important. Since managing a plurality of sensor devices individually is practically impossible for humans, the status of IoT devices may be managed using the UE status information by the capabilities provided by the 3GPP network. Accordingly, the control center of the enterprise may request UE status monitoring by using an API provided by the SNAF to the outside of the 3GPP network. As described in the above embodiments, the SNAF may expose the service capabilities provided by the 3GPP network to external networks on behalf of the 3GPP network, and may provide APIs that external application servers can use.

Due to the nature of enterprise services, it may be necessary to identify the status of UEs belonging to a specific group. In this case, the control center of the enterprise may transmit only the identifier (e.g., group ID) of the group to the SNAF. In addition, the SNAF may identify the status of the individual UEs within the group. Accordingly, the SNAF may also provide management functions for service-specific groups and group members. The UE monitoring procedure described above may proceed as follows.

In operation 2010, the control center of an enterprise located outside the 3GPP network may transmit a UE monitoring request message (e.g., UE Monitoring request) to the SNAF. The UE monitoring request message may include at least one of a UE identifier, a UE group identifier, and information regarding monitoring conditions. The monitoring conditions may refer to information indicating a monitoring target such as location or status, a monitoring type, or a monitoring duration. The control center may also receive a UE monitoring response message (e.g., UE Monitoring response) from the SNAF.

In operation 2020, the SNAF may store UE monitoring information (e.g., at least one of information on a UE identifier, a UE group identifier, a monitoring duration, or a monitoring type).

In operation 2030, the SNAF may transmit a UE monitoring request message (e.g., Nsnaf_UeMonitoring request) to the AMF. The UE monitoring request message may include at least one of information on a target UE identifier, a monitoring duration, or a monitoring type. When the UE status information is requested for a specific UE group, the UE monitoring request message may be transmitted in units of individual UEs within the group.

In operation 2040, when the UE is already registered in the 5G network, the AMF may identify the UE status based on the monitoring conditions.

In operation 2050, the AMF may transmit a UE monitoring response message (e.g., Nsnaf_UeMonitoring response) to the SNAF. The UE monitoring response message may include at least one of a UE identifier, a monitoring type, or a monitoring result that is identified in operation 2040.

In operation 2060, the SNAF may transmit a UE monitoring notification message (e.g., UE Monitoring Notify request) to the enterprise control center located outside the 3GPP network. The UE monitoring notification message may include at least one of a UE identifier and information regarding monitoring conditions. The monitoring condition may indicate the type of monitoring, such as location or status. In addition, the control center may analyze whether policy/QoS has been properly enforced by using at least one piece of information included in the UE monitoring notification message.

In operation 2070, when the UE is not registered in the 5G network, the AMF may store a monitoring configuration. Furthermore, the AMF may wait for the target UE to register in the 3GPP network within a period configured by the monitoring condition.

In operation 2080, when the monitoring condition is configured as “continuous,” the AMF may transmit a monitoring report to the SNAF upon the occurrence of an event related to the target UE, and the UE status may be changed accordingly.

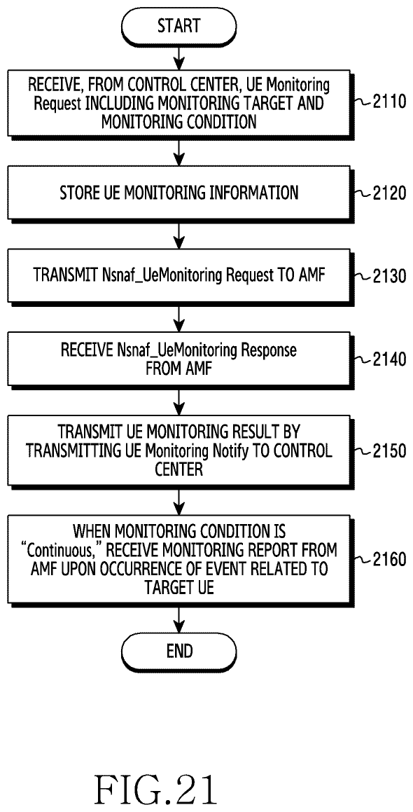

FIG. 21 illustrates a SNAF-based UE status monitoring sequence according to an embodiment of the disclosure.

Referring to FIG. 21, an operational sequence of the SNAF for performing a UE status monitoring procedure in a network in which the SNAF is deployed may be explained.

In operation 2110, the SNAF may receive a UE monitoring request message (e.g., UE Monitoring request) from an enterprise control center located outside the 3GPP network. The UE monitoring request message may include at least one of a UE identifier, a UE group identifier, and information regarding monitoring conditions. The monitoring condition may refer to information indicating a monitoring target such as location or status, a monitoring type, or a monitoring duration. The SNAF may also transmit a UE monitoring response message (e.g., UE Monitoring response) to the control center.

In operation 2120, the SNAF may store UE monitoring information (e.g., at least one of information on a UE identifier, a UE group identifier, a monitoring duration, or a monitoring type).

In operation 2130, the SNAF may transmit a UE monitoring request message (e.g., Nsnaf_UeMonitoring request) to the AMF. The UE monitoring request message may include at least one of information of a target UE identifier, a monitoring duration, or a monitoring type. When UE status information is requested for a specific UE group, the UE monitoring request message may be transmitted in units of individual UEs within the group.

In operation 2140, the SNAF may receive a UE monitoring response message (e.g., Nsnaf_UeMonitoring response) from the AMF. The UE monitoring response message may include at least one of a UE identifier, a monitoring type, or a monitoring result.

In operation 2150, the SNAF may transmit a UE monitoring notification message (e.g., UE Monitoring Notify request) to the enterprise control center located outside the 3GPP network. The UE monitoring notification message may include at least one of a UE identifier and information regarding monitoring conditions. The monitoring condition may indicate the type of monitoring, such as location or status.

In operation 2160, when the monitoring condition is configured as “continuous,” the SNAF may receive monitoring reports from the AMF upon the occurrence of events related to the target UE, and the UE status may be changed accordingly.

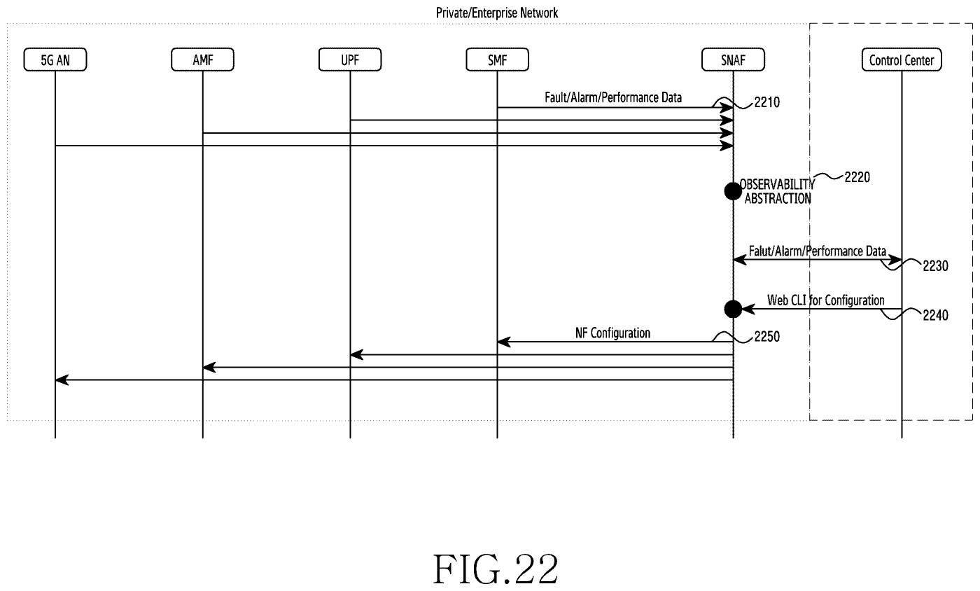

FIG. 22 illustrates a signal flow of a SNAF-based enterprise private network monitoring procedure according to an embodiment of the disclosure.

Referring to FIG. 22, a network monitoring procedure in a network in which the SNAF is deployed may be explained. Depending on the operation status of the enterprise private network, each of NFs may generate at least one of failure (or fault), alarm, or performance data. These NFs may transmit the generated data to the SNAF. The fault, alarm, and performance data may be considered operational data, and such data may be automatically delivered to the SNAF through the operational functions of each NF without the need for a separate request from the SNAF. The SNAF may provide observability for network operations. The SNAF may provide APIs that allow the enterprise control center to access 3GPP network operational information, so as to provide observability to the outside of the 3GPP network. In addition, the SNAF may provide a web command line interface (CLI) to support enabling the enterprise control center located outside the 3GPP network to easily perform configuration of 3GPP NFs.

In operation 2210, each NF inside the enterprise private network may transmit at least one of fault, alarm, or performance data to the SNAF.

In operation 2220, the SNAF may store at least one of the fault, alarm, or performance data received from each NF, and provide observability of the 3GPP network to the outside of the enterprise control center.

In operation 2230, the SNAF may transmit at least one of the fault, alarm, or performance data to the control center.

In operation 2240, the SNAF may provide, to the control center, a web CLI for supporting the NF configuration of the 3GPP network. The control center may transmit configuration information for each NF in the 3GPP network to the SNAF via the web CLI.

In operation 2250, based on the configuration information received from the control center, the SNAF may perform configuration operations for each NF in the 3GPP network.

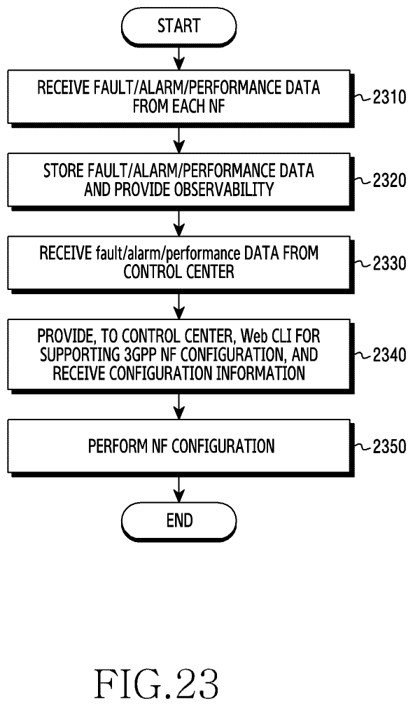

FIG. 23 illustrates a SNAF-based enterprise private network monitoring sequence according to an embodiment of the disclosure.

Referring to FIG. 23, an operational sequence of the SNAF in a SNAF-based network monitoring procedure may be explained.

In operation 2310, the SNAF may receive at least one of fault, alarm, or performance data from each NF within the enterprise private network.

In operation 2320, the SNAF may store at least one of the fault, alarm, or performance data received from each NF, and may provide observability of the 3GPP network to the outside of the 3GPP network.

In operation 2330, the SNAF may transmit at least one of the fault, alarm, or performance data to a control center.

In operation 2340, the SNAF may provide, to the control center, a web CLI for supporting NF configuration of the 3GPP network, and the control center may transmit configuration information for each NF in the 3GPP network to the SNAF via the Web CLI.

In operation 2350, based on the configuration information received from the control center, the SNAF may perform configuration for each NF in the 3GPP network.

The structure and functions of the enterprise private network using the SNAF are not limited to the embodiments described above. The structure and functions of the enterprise private network according to embodiments of the disclosure may represent embodiments considering general enterprise requirements. Therefore, it is possible to configure an enterprise private network according to specific enterprise demands by combining or modifying some or all of the structures and functions of the SNAF in the embodiments described above or by adding functions of the 3GPP network.

A method of operating a secure network abstraction function (SNAF) entity for operating a private network according to an embodiment of the disclosure may include receiving a first control message from a first network entity, and performing a control operation on a second network entity, based on the first control message, wherein the first network entity is a control center included in the private network, the second network entity is at least one of a session management function (SMF) entity, an access and mobility management function (AMF) entity, or a user plane function (UPF) entity, and wherein the first network entity and the SNAF entity are connected via an application programming interface (API), and the SNAF entity and the second network entity are connected via a service-based interface (SBI).

In an embodiment, the performing of the control operation on the second network entity may include receiving, from the second network entity, an authentication request message in case that the first control message includes authentication information for the second network entity, transmitting the authentication information for the second network entity to the second network entity in response to the authentication request message, and performing management of the authentication information.

In an embodiment, the performing of the control operation on the second network entity may include, in case that the first control message includes policy control information for policy update of at least one of an individual terminal or group terminals, mapping the policy control information to an attribute for the second network entity, and transmitting the policy control information to the second network entity.

In an embodiment, the performing of the control operation on the second network entity may include, in case that the first control message includes usage reporting configuration information for a network resource, transmitting the usage reporting configuration information to the second network entity, receiving information on the usage of the network resource from the second network entity, and reporting the information on the usage of the network resource to the first network entity.

In an embodiment, the performing of the control operation on the second network entity may include, in case that the first control message includes monitoring configuration information of a terminal, transmitting the monitoring configuration information to the second network entity, receiving the monitoring configuration information of the terminal from the second network entity, and reporting the monitoring configuration information to the first network entity in case that the terminal is registered in the private network, wherein the monitoring configuration information includes at least one of information on an identifier of a target terminal, a monitoring duration, or a monitoring type.

In an embodiment, the method may further include receiving a second control message from the second network entity, and performing a control operation on the first network entity, based on the second control message, wherein the performing of the control operation on the first network entity may include transmitting the second control message to the first network entity, receiving configuration information generated based on the second control message from the first network entity via a command line interface (CLI), and transmitting the configuration information to the second network entity, wherein the second control message includes at least one of fault, alarm, or performance data.

In an embodiment, the method may further include, in case that a registration request message for access control of a terminal is received from the second network entity, requesting the access control from the first network entity, receiving a result of performing the access control from the first network entity, and transmitting the result of performing the access control to the second network entity.

In an embodiment, the method may further include receiving an access and mobility policy control request message from the second network entity, and in response to the access and mobility policy control request message, transmitting information on a preconfigured access and mobility policy to the first network entity.

In an embodiment, the method may further include, in case that a registration request message for session control of a terminal is received from the second network entity, requesting the session control from the first network entity, receiving a result of performing the session control from the first network entity, and transmitting the result of performing the session control to the second network entity.

In an embodiment, the method may further include receiving a session and mobility policy control request message from the second network entity, and in response to the session and mobility policy control request message, transmitting information on a preconfigured session and mobility policy to the first network entity.

A secure network abstraction function (SNAF) entity for operating a private network according to an embodiment of the disclosure may include at least one transceiver, and at least one processor operatively coupled to the at least one transceiver, wherein the at least one processor is configured to receive a first control message from a first network entity, and perform a control operation on a second network entity, based on the first control message, wherein the first network entity is a control center included in the private network, and the second network entity is at least one of a session management function (SMF) entity, an access and mobility management function (AMF) entity, or a user plane function (UPF) entity, and wherein the first network entity and the SNAF entity are connected via an application programming interface (API), and the SNAF entity and the second network entity are connected via a service-based interface (SBI).

In an embodiment, in case that the first control message includes authentication information for the second network entity, an authentication request message is received from the second network entity, the authentication information for the second network entity is transmitted to the second network entity in response to the authentication request message, and management of the authentication information may be performed.

In an embodiment, in case that the first control message includes policy control information for updating the policy of at least one of an individual terminal or a group of terminals, the policy control information is mapped to an attribute for the second network entity, and the policy control information may be transmitted to the second network entity.

In an embodiment, in case that the first control message includes usage reporting configuration information for a network resource, the usage reporting configuration information is transmitted to the second network entity, information on the usage of the network resource is received from the second network entity, and the information on the usage of the network resource may be reported to the first network entity.

In an embodiment, in case that the first control message includes monitoring configuration information for a terminal, the monitoring configuration information is transmitted to the second network entity, the monitoring configuration information of the terminal is received from the second network entity, and the monitoring configuration information is reported to the first network entity in case that the terminal is registered in the private network, wherein the monitoring configuration information may include at least one of information on an identifier of the target terminal, a monitoring duration, or a monitoring type.

In an embodiment, a second control message is received from the second network entity, the second control message is transmitted to the first network entity, configuration information generated based on the second control message is received from the first network entity via a command line interface (CLI), and the configuration information is transmitted to the second network entity, wherein the second control message may include at least one of fault, alarm, or performance data.

In an embodiment, in case that a registration request message for access control of a terminal is received from the second network entity, the access control is requested from the first network entity, a result of performing the access control is received from the first network entity, and the result of performing the access control may be transmitted to the second network entity.

In an embodiment, an access and mobility policy control request message is received from the second network entity, and in response to the access and mobility policy control request message, information on a preconfigured access and mobility policy may be transmitted to the first network entity.

In an embodiment, in case that a registration request message for session control of a terminal is received from the second network entity, the session control is requested from the first network entity, a result of performing the session control is received from the first network entity, and the result of performing the session control may be transmitted to the second network entity.

In an embodiment, a session and mobility policy control request message is received from the second network entity, and in response to the session and mobility policy control request message, information on a preconfigured session and mobility policy may be transmitted to the first network entity.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including random access memory and flash memory, read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural.

While the disclosure has been shown and described with reference to various embodiments thereof, it will be understood by those skilled in the art that various changes in form and details may be made therein without departing from the spirit and the scope of the disclosure as defined by the appended claims and their equivalents.

What is claimed is:

1. A method performed by a secure network abstraction function (SNAF) entity for operating a private network, the method comprising:
receiving a first control message from a first network entity; and
performing a control operation for a second network entity, based on the first control message,
wherein the first network entity is a control center included in the private network, and the second network entity is at least one of a session management function (SMF) entity, an access and mobility management function (AMF) entity, or a user plane function (UPF) entity, and
wherein the first network entity and the SNAF entity are connected via an application programming interface (API), and the SNAF entity and the second network entity are connected via a service-based interface (SBI).

2. The method of claim 1, wherein the performing of the control operation for the second network entity comprises:
in case that the first control message comprises authentication information of the second network entity, receiving an authentication request message from the second network entity;
in response to the authentication request message, transmitting the authentication information of the second network entity to the second network entity; and
performing management of the authentication information.

3. The method of claim 1, wherein the performing of the control operation for the second network entity comprises:
in case that the first control message comprises policy control information for policy update of at least one of individual terminals or a group of terminals, mapping the policy control information to an attribute of the second network entity; and
transmitting the policy control information to the second network entity.

4. The method of claim 1, wherein the performing of the control operation for the second network entity comprises:
in case that the first control message comprises usage reporting configuration information of network resources, transmitting the usage reporting configuration information to the second network entity;
receiving usage information of the network resources from the second network entity; and
reporting the usage information of the network resources to the first network entity.

5. The method of claim 1,
wherein the performing of the control operation for the second network entity comprises:
in case that the first control message comprises monitoring configuration information of a terminal, transmitting the monitoring configuration information to the second network entity,
receiving monitoring information of the terminal from the second network entity, and
in case that the terminal is registered in the private network, reporting the monitoring information to the first network entity, and
wherein the monitoring configuration information comprises at least one of information on an identifier of a target terminal, a monitoring duration, or a monitoring type.

6. The method of claim 1, further comprising:
receiving a second control message from the second network entity; and
performing a control operation for the first network entity, based on the second control message,
wherein the performing of the control operation for the first network entity comprises:
transmitting the second control message to the first network entity,
receiving configuration information generated based on the second control message from the first network entity via a command line interface (CLI), and
transmitting the configuration information to the second network entity, and
wherein the second control message comprises at least one of fault, alarm, or performance data.

7. The method of claim 1, further comprising:
in case that a registration request message for access control of a terminal is received from the second network entity, requesting the access control from the first network entity;
receiving a result of performing the access control from the first network entity; and
transmitting the result of performing the access control to the second network entity.

8. The method of claim 7, further comprising:
receiving an access and mobility policy control request message from the second network entity; and
in response to the access and mobility policy control request message, transmitting information on a preconfigured access and mobility policy to the first network entity.

9. A secure network abstraction function (SNAF) entity for operating a private network, the SNAF entity comprising:
a transceiver;
at least one processor; and
memory storing instructions that, when executed by the at least one processo, cause the SNAF entity to:
receive a first control message from a first network entity, and
perform a control operation for a second network entity, based on the first control message,
wherein the first network entity is a control center included in the private network, and the second network entity is at least one of a session management function (SMF) entity, an access and mobility management function (AMF) entity, or a user plane function (UPF) entity, and
wherein the first network entity and the SNAF entity are connected via an application programming interface (API), and the SNAF entity and the second network entity are connected via a service-based interface (SBI).

10. The SNAF entity of claim 9, wherein the memory further comprises the instructions that, when executed by the at least one processor, cause the SNAF entity to:
in case that the first control message comprises authentication information of the second network entity, receive an authentication request message from the second network entity,
in response to the authentication request message, transmit the authentication information of the second network entity to the second network entity, and perform management of the authentication information.

11. The SNAF entity of claim 9, wherein the memory further comprises the instructions that, when executed by the at least one processor, cause the SNAF entity to:
in case that the first control message comprises policy control information for policy update of at least one of individual terminals or a group of terminals, map the policy control information to an attribute of the second network entity, and
transmit the policy control information to the second network entity.

12. The SNAF entity of claim 9, wherein the memory further comprises the instructions that, when executed by the at least one processor, cause the SNAF entity to:
in case that the first control message comprises usage reporting configuration information of network resources, transmit the usage reporting configuration information to the second network entity,
receive usage information of the network resources from the second network entity, and
report the usage information of the network resources to the first network entity.

13. The SNAF entity of claim 9,
wherein the memory further comprises the instructions that, when executed by the at least one processor, cause the SNAF entity to:
in case that the first control message comprises monitoring configuration information of a terminal, transmit the monitoring configuration information to the second network entity,
receive monitoring information of the terminal from the second network entity, and
in case that the terminal is registered in the private network, report the monitoring information to the first network entity, and
wherein the monitoring configuration information comprises at least one of information on an identifier of a target terminal, a monitoring duration, or a monitoring type.

14. The SNAF entity of claim 9,
wherein the memory further comprises the instructions that, when executed by the at least one processor, cause the SNAF entity to:
receive a second control message from the second network entity,
transmit the second control message to the first network entity,
receive configuration information generated based on the second control message from the first network entity via a command line interface (CLI), and
transmit the configuration information to the second network entity, and
wherein the second control message comprises at least one of fault, alarm, or performance data.

15. The SNAF entity of claim 9, wherein the memory further comprises the instructions that, when executed by the at least one processor, cause the SNAF entity to:
in case that a registration request message for access control of a terminal is received from the second network entity, request the access control from the first network entity,
receive a result of performing the access control from the first network entity, and
transmit the result of performing the access control to the second network entity.

16. The SNAF entity of claim 15, wherein the memory further comprises the instructions that, when executed by the at least one processor, cause the SNAF entity to:
receive an access and mobility policy control request message from the second network entity, and
in response to the access and mobility policy control request message, transmit information on a preconfigured access and mobility policy to the first network entity.
